(19) United States
(12) Patent Application Publication
(10) Pub. No.: US 2003/0030889 A1
(43) Pub. Date: Feb. 13, 2003

(54) Optical isolator for transmitting light propagating forward and not transmitting light propagating backward, laser module using the optical isolator, optical amplifier using the optical isolator and polarizing filter used for a polarizer and an analyzer of the optical isolator

(76) Inventors: Kiyohide Sakai, Tokyo (JP); Yuuhiko Hamada, Tokyo (JP); Hidekazu Kodera, Tokyo (JP)

Correspondence Address: Platon N. Mandros, Esq., BURNS, DOANE, SWECKER & METHIS, L.L.P., P.O. Box 1404, Alexandria, VA, 22313-1404, US

(21) Appl. No.: 10/200,383

(22) Filed: Jul. 23, 2002

Related U.S. Application Data
(63) Continuation-in-part of application No. 10/061,232, filed on Feb. 4, 2002.

(30) Foreign Application Priority Data
Aug. 9, 2001 (JP) 2001-242293
Apr. 15, 2002 (JP) 2002-112519

(51) Int. Cl. H01S 3/00

(52) U.S. Cl. 359/333

(57) ABSTRACT

A laser beam is incident on a polarizer inclined by an inclined angle ranging from 50 to 60 degrees with respect to an optical axis, a polarized component of the laser beam polarized in a first polarization direction passes through the polarizer. The polarized component is rotated on the optical axis in a second polarization direction by 45 degrees in a Faraday rotator and is incident on an analyzer which is inclined by the inclined angle in a direction opposite to that of the inclination of the polarizer with respect to the optical axis to transmit only a laser beam polarized in the second polarization direction. Therefore, the polarized component passes through the analyzer almost without attenuation, and a wave front aberration of the laser beam caused by the polarizer is cancelled out in the analyzer.

### CROSS-REFERENCE TO THE RELATED APPLICATION

This application is a continuation-in-part of the patent application Ser. No. 10/061,232, whose filing date is Feb. 4, 2002.

### BACKGROUND OF THE INVENTION

1. Field of the Invention

The present invention relates to an optical isolator through which an optical signal propagating forward is transmitted but an optical signal propagating backward is not transmitted. Also, the present invention relates to a laser module and a light amplifier in which the optical isolator is used. Also, the present invention relates to a polarizing filter formed of a dielectric multi-layer film.

2. Description of Related Art

FIG. 23 is a view showing the configuration of an optical element applied for a conventional optical isolator, and FIG. 24 is a view showing the configuration of the conventional optical isolator. The conventional optical isolator shown in FIG. 24 has been disclosed in Published Unexamined Japanese Patent Application No. H8-166561 of 1996.

In FIG. 23, 101 indicates an optical element (or a dielectric multi-layer thin film element). 102 indicates a Faraday effect element plate, for example, formed of yttrium-iron-garnet (YIG) crystal or an LPE garnet film. 103 indicates an antireflection film arranged on one surface of the Faraday effect element plate 102. 104 indicates a polarized wave separating film arranged on the other surface of the Faraday effect element plate 102. The optical element 101 is composed of the Faraday effect element plate 102, the antireflection film 103 and the polarized wave separating film 104.

Also, in FIG. 24, 105 indicates a polarizer. The polarizer 105 is obtained by arranging a polarized wave separating film on one surface of a half-wave plate, and a laser beam is incident on the polarized wave separating film of the polarizer 105. The polarized wave separating film is formed by coating the half-wave plate with a dielectric multi-layer thin film. 106 indicates a Faraday rotator. The Faraday rotator 106 is composed of the optical element 101 and a magnet 106M attached to the optical element 101, and the polarized wave separating film 104 of the optical element 101 functions as an analyzer.

In the conventional optical isolator, as shown in FIG. 24, the polarizer 105 and the Faraday rotator 106 are arranged in parallel to each other. Therefore, when a laser beam radiated from a semiconductor laser (not shown) is incident on the conventional optical isolator, a light component (hereinafter, called P-polarized component) polarized in parallel to the plane of incidence and a light component (hereinafter, called S-polarized component) perpendicularly polarized to the plane of incidence are separated from each other in the polarizer 105, and the P-polarized component of the laser beam is input to the Faraday rotator 106. In the Faraday rotator 106, the P-polarized component of the laser beam is rotated on an optical axis of the Faraday rotator 106 by 45 degrees in a rotation direction according to a magnetic field. Thereafter, the rotated P-polarized component of the laser beam is coupled to an optical fiber (not shown) to transmit the rotated P-polarized component to an external device as a laser beam.

Also, in cases where a part of the rotated P-polarized component of the laser beam is reflected from the optical fiber to the conventional optical isolator as a returned laser beam, the returned laser beam is again rotated on the optical axis of the Faraday rotator 106 by 45 degrees in the rotation direction. Therefore, a polarization direction of the returned laser beam differs from that of the P-polarized component of the laser beam radiated from the semiconductor laser by 90 degrees. When the returned laser beam output from the Faraday rotator 106 is input to the polarizer 105, because the polarization direction of the returned laser beam is shifted by 90 degrees, the transmission of the returned laser beam is prevented in the polarizer 105, and no returned laser beam is returned to the semiconductor laser. Therefore, the semiconductor laser is isolated from the returned laser beam by the conventional optical isolator.

Also, another optical fiber (not shown) is disclosed in the Published Unexamined Japanese Patent Application No. H8-166561 of 1996. In this optical fiber, two Faraday effect element plates 102 shown in FIG. 23 are used, a dielectric multi-layer thin film placed on a surface of one Faraday effect element plate 102 functions as a polarizer to transmit a P-polarized component of an incident laser beam, and a dielectric multi-layer thin film placed on a surface of the other Faraday effect element plate 102 functions as an analyzer. Also, in this optical fiber, a Faraday rotation angle of each Faraday effect element plate 102 is set to 22.5 degrees, and each Faraday effect element plate 102 is inclined by a prescribed angle with respect to the incident laser beam so as to finally rotate the P-polarized component of the incident laser beam by 45 degrees.

However, because the polarizer 105 and the Faraday rotator 106 are arranged in parallel to each other in the conventional optical isolator, a problem has arisen that a wave front aberration of the laser beam caused by the polarizer 105 is increased the Faraday rotator 106. FIG. 25A and FIG. 25B are explanatory views showing a wave front aberration of the laser beam occurring in the conventional optical isolator. The laser beam is conceptually indicated by a plurality of incident waves (or a plurality of plane waves). As shown in FIG. 25A, a plane parallel plate 107 is arranged so as to be inclined with respect to wave fronts of the incident waves. When the incident waves are incident on the plane parallel plate 107, a wave front aberration generally occurs in the incident waves due to the deep incident angle to the plane parallel plate 107, and the incident waves having the wave front aberration are propagated. Therefore, in the conventional optical isolator, as shown in FIG. 25B, because the polarizer 105 and the Faraday rotator 106 are arranged in parallel to each other so as to be inclined with respect to wave fronts of the incident waves indicating the laser beam, a wave front aberration of the laser beam occurs in the polarizer 105, and the wave front aberration of the laser beam is further increased in the Faraday rotator 106.

### SUMMARY OF THE INVENTION

An object of the present invention is to provide, with due consideration to the drawbacks of the conventional optical isolator, an optical isolator in which a wave front aberration of a laser beam is reduced.

Also, the object of the present invention is to provide a laser module and a light amplifier in which the optical isolator is used.

Also, the object of the present invention is to provide a polarizing filter having a dielectric multi-layer film preferably used for both a polarizer and an analyzer of the optical isolator.

The object is achieved by the provision of an optical isolator including a rotator having an optical axis, a parallel-plate polarizer disposed on the optical axis of the rotator so as to be inclined with respect to the optical axis of the rotator, and a parallel-plate analyzer disposed on the optical axis of the rotator and opposite to the polarizer through the rotator. The parallel-plate analyzer is configured to reduce a wave front aberration generated by the polarizer.

In the above configuration, a wave front aberration of a laser beam caused by the polarizer is cancelled out in the analyzer. Accordingly, because the wave front aberration of the laser beam caused by the polarizer is reduced in the analyzer, the wave front aberration of the laser beam can be reduced.

The object is also achieved by the provision of an optical isolator including a rotator having an optical axis and configured to rotate a polarization of a laser beam by a prescribed rotation angle on the optical axis of the rotator, a parallel-plate polarizer disposed on the optical axis of the rotator and inclined by a first angle in an inclined direction with respect to the optical axis of the rotator, and a parallel-plate analyzer disposed on the optical axis of the rotator and opposite to the polarizer through the rotator and inclined by a second angle in an inclined direction opposite to that of the polarizer with respect to the optical axis of the rotator.

In the above configuration, a wave front aberration of a laser beam caused by the polarizer is cancelled out in the analyzer inclined in a direction opposite to that of the first angle. Accordingly, because the wave front aberration of the laser beam caused by the polarizer is reduced in the analyzer, the wave front aberration of the laser beam can be reduced.

The object is also achieved by the provision of an optical isolator including a rotator having an optical axis, a parallel-plate polarizer crossing the optical axis and disposed on one side of the rotator, and a parallel-plate analyzer crossing the optical axis and disposed on the other side of the rotator. The polarizer, the analyzer and the rotator have substantially the same arrangement as that of an imaginary polarizer, an imaginary analyzer, and an imaginary rotator arranged on condition that the imaginary analyzer is placed in a perpendicular relationship to an optical axis of the imaginary rotator, and the imaginary polarizer is placed so as to make a first polarization plane of a polarized laser beam allowed to be transmitted through the imaginary polarizer be parallel with a second polarization plane of a polarized laser beam allowed to be transmitted through the imaginary analyzer. The imaginary polarizer and the imaginary analyzer are tilted to each other with respect to the optical axis of the imaginary rotator so as to make a first intersection line of the imaginary polarizer and the first polarization plane face a second intersection line of the imaginary analyzer and the second polarization plane in an almost v shape. The imaginary analyzer is rotated on the optical axis of the imaginary rotator so as to make the first polarization plane incline at an angle of about 45 degrees with respect to the second polarization plane. A rotation angle of the imaginary rotator is set at about 45 degrees by which a polarization plane of a polarized laser beam rotates on the optical axis.

In the above configuration, a wave front aberration of a laser beam caused by the polarizer is cancelled out in the analyzer. Accordingly, because the wave front aberration of the laser beam caused by the polarizer is reduced in the analyzer, the wave front aberration of the laser beam can be reduced.

The object is also achieved by the provision of a laser module including an optical isolator, a laser beam source configured to radiate a laser beam, and a beam collimator configured to collimate the laser beam radiated from the laser beam source and sending the laser beam to the optical isolator. The optical isolator comprises a rotator having an optical axis, a parallel-plate polarizer placed so as to be inclined with respect to the optical axis, and having a polarized beam transmission characteristic of a first polarization direction, and a parallel-plate analyzer placed across the rotator from the polarizer, and configured to reduce a wave front aberration generated by the polarizer. The analyzer has a polarized beam transmission characteristic of a second polarization direction.

Therefore, the laser beam radiated from the semiconductor laser can be efficiently transmitted to an optical fiber through the optical isolator.

The object is also achieved by the provision of a light amplifier including a laser module, an optical signal receiving unit configured to receive an optical signal, an optical signal and excited beam coupling unit configured to couple the optical signal received by the optical signal receiving unit with a laser beam which is output from the laser module and functions as an excited laser beam, and an optical signal amplifying path configured to receive the optical signal and the excited laser beam from the optical signal and excited beam coupling unit, amplifying the optical signal according to the excited laser beam and outputting the optical signal. The laser module comprises an optical isolator, a laser beam source configured to radiate a laser beam, and a beam collimator configured to collimate the laser beam radiated from the laser beam source and sending the laser beam to the optical isolator. The optical isolator comprises a rotator having an optical axis, a parallel-plate polarizer placed so as to be inclined with respect to the optical axis, and having a polarized beam transmission characteristic of a first polarization direction, and a parallel-plate analyzer placed across the rotator from the polarizer, and configured to reduce a wave front aberration generated by the polarizer. The analyzer has a polarized beam transmission characteristic of a second polarization direction,

Therefore, the optical signal can be efficiently amplified in the light amplifier according to the excited laser beam in which noise is reduced.

The object is also achieved by the provision of a light amplifier including an optical isolator, a laser beam source configured to radiate an excited laser beam, an optical signal receiving unit configured to receive an optical signal, an optical signal and excited beam coupling unit configured to couple the optical signal received by the optical signal receiving unit with the excited laser beam radiated from the laser beam source, and an optical signal amplifying path configured to receive the optical signal and the excited laser beam from the optical signal and excited beam coupling unit, to amplify the optical signal according to the excited laser beam and to output the optical signal. The optical isolator is placed on an input side or an output side of the optical signal amplifying path. The optical isolator comprises a rotator having an optical axis, a parallel-plate polarizer placed so as to be inclined with respect to the optical axis, and having a polarized beam transmission characteristic of a first polarization direction, and a parallel-plate analyzer placed across the rotator from the polarizer, and configured to reduce a wave front aberration generated by the polarizer. The analyzer has a polarized beam transmission characteristic of a second polarization direction.

Therefore, the oscillation of a returned laser beam in the light amplifier can be prevented.

The object is also achieved by the provision of an optical isolator, including a parallel-plate polarizer having a first polarization direction which is parallel to a first polarization plane of a polarized laser beam allowed to be transmitted through the polarizer, a parallel-plate analyzer having a second polarization direction which is parallel to a second polarization plane of a polarized laser beam allowed to be transmitted through the analyzer, and a rotator disposed between the polaraizer and the analyzer and having an optical axis crossing the polarizer and the analyzer. The rotator rotates a polarization of a polarized laser beam on the optical axis by a rotation angle of about 45 degrees in a direction of rotation. The polarizer and the analyzer have substantially the same arrangement as that of an imaginary polarizer and an imaginary analyzer arranged on condition that the imaginary analyzer is placed in a parallel relationship to the imaginary polarizer so as to make the second polarization direction of the analyzer be parallel with the first polarization direction of the polarizer, and then the imaginary analyzer is rotated on the optical axis of the rotator by a rotation angle of about 225 degrees in the direction of rotation of the rotator.

In the above configuration, a wave front aberration of a laser beam caused by the polarizer is cancelled out in the analyzer. Accordingly, because the wave front aberration of the laser beam caused by the polarizer is reduced in the analyzer, the wave front aberration of the laser beam can be reduced.

The object is also achieved by the provision of an optical isolator including a parallel-plate polarizer having a first polarization direction which is parallel to a first polarization plane of a polarized laser beam allowed to be transmitted through the polarizer, a parallel-plate analyzer having a second polarization direction which is parallel to a second polarization plane of a polarized laser beam allowed to be transmitted through the analyzer, and a rotator disposed between the polaraizer and the analyzer and having an optical axis crossing the polarizer and the analyzer. The rotator rotates a polarization of a polarized laser beam on the optical axis by a rotation angle of about 45 degrees in a direction of rotation. The polarizer and the analyzer have substantialy the same arrangement as that which is made by the following steps of disposing the analyzer in a parallel relationship to the polarizer so as to make the second polarization direction of the analyzer be parallel with the first polarization direction of the polarizer, and rotating the analyzer on the optical axis of the rotator by a rotation angle of about 225 degrees in the direction of rotation of the rotator.

In the above configuration, a wave front aberration of a laser beam caused by the polarizer is cancelled out in the analyzer. Accordingly, because the wave front aberration of the laser beam caused by the polarizer is reduced in the analyzer, the wave front aberration of the laser beam can be reduced.

The object is also achieved by the provision of a polarizing filter including a plurality of high refractive index type dielectric thin films formed on a film-forming plane and a plurality of low refractive index type dielectric thin films formed on the film-forming plane so as to form a dielectric multi-layer film with the high refractive index type dielectric thin films.

In the above configuration, because the dielectric multi-layer film is formed of the high refractive index type dielectric thin films and the low refractive index type dielectric thin films, a P-polarized component and an S-polarized component of a laser beam incident on the polarizing filter can be separated from each other in a wide wavelength band as compared with the prior art.

Accordingly, the polarizing filter can be preferably used for both a polarizer and an analyzer of an optical isolator.

### BRIEF DESCRIPTION OF THE DRAWINGS

FIG. 1 is a view showing the configuration of a dielectric multi-layer thin film filter applied for an optical isolator according to a first embodiment of the present invention;

FIG. 2 shows a film thickness of a low refractive index type substance, a film thickness of a high refractive index type substance and the arrangement of the film of the low refractive index type substance placed between the two films of the high refractive index type substance in a dielectric multi-layer thin film as an example;

FIG. 3 shows transmission characteristics of a dielectric multi-layer thin film filter for both a P-polarized component and a S-polarized component;

FIG. 4 is a view showing the configuration of an optical isolator according to the first embodiment of the present invention;

FIG. 5A is a side view showing a layout of both a polarizer and an analyzer placed perpendicular to an optical axis;

FIG. 5B is a front view showing a layout of both the polarizer and the analyzer placed perpendicular to the optical axis;

FIG. 6A is a side view showing the polarizer inclined with respect to the optical axis and the analyzer placed perpendicular to the optical axis;

FIG. 6B is a front view showing the polarizer inclined with respect to the optical axis and the analyzer placed perpendicular to the optical axis;

FIG. 7A is a side view showing the polarizer inclined with respect to the optical axis and the analyzer inclined in a direction opposite to that of the inclination of the polarizer;

FIG. 7B is a front view showing the polarizer inclined with respect to the optical axis and the analyzer inclined in a direction opposite to that of the inclination of the polarizer;

FIG. 8A is a side view showing the polarizer inclined with respect to the optical axis and the analyzer which is inclined in the direction opposite to that of the inclination of the polarizer and is rotated on the optical axis by 45 degrees;

FIG. 8B is a side view showing the polarizer inclined with respect to the optical axis and the analyzer which is inclined in the direction opposite to that of the inclination of the polarizer and is rotated on the optical axis by 45 degrees;

FIG. 9A shows a view of a laser beam transmitted forward through the optical isolator;

FIG. 9B shows a view of the laser beam transmitted backward through the optical isolator;

FIG. 10 is a conceptual view showing the reduction of a wave front aberration of incident waves obtained in the optical isolator according to the first embodiment of the present invention;

FIG. 11 is a view showing the relationship between the inclined placement angle and the reduction of the wave front aberration;

FIG. 12 is a view showing the configuration of a dielectric multi-layer thin film filter with an antireflection film applied for an optical isolator according to a modification of the first embodiment of the present invention;

FIG. 13 is a schematic view showing the configuration of a light amplifier according to the first embodiment of the present invention;

FIG. 14 is a schematic view showing the configuration of another light amplifier according to the first embodiment of the present invention;

FIG. 15 is a schematic view showing the configuration of another light amplifier according to the first embodiment of the present invention;

FIG. 16 shows an example of a film structure of a polarizing filter formed of dielectric substances which are used for the dielectric multi-layer thin film 3 shown in FIG. 1;

FIG. 17 shows transmission characteristics of the polarizing filter having the film structure shown in FIG. 16 for both a P-polarized component and an S-polarized component of a laser beam;

FIG. 18 shows a polarized component separation ratio obtained from an S-polarized component transmittance Ts and a P-polarized component transmittance Tp shown in FIG. 17;

FIG. 19A is a view of the configuration of a polarizing filter according to a second embodiment of the present invention;

FIG. 19B shows a film structure of the polarizing filter shown in FIG. 19A;

FIG. 20 shows transmission characteristics of the polarizing filter having the film structure shown in FIG. 19B for both a P-polarized component and an S-polarized component of a laser beam;

FIG. 21 shows a polarized component separation ratio obtained from an S-polarized component transmittance Ts and a P-polarized component transmittance Tp shown in FIG. 20;

FIG. 22 is a view showing the configuration of a semiconductor laser module having both a semiconductor laser and an optical isolator in which the polarizing filter 31 having the film structure shown in FIG. 19B is used as a polarizer and an analyzer;

FIG. 23 is a view showing the configuration of an optical element applied for a conventional optical isolator;

FIG. 24 is a view showing the configuration of the conventional optical isolator;

FIG. 25A is a view showing a wave front aberration generally occurring in a plain parallel plate; and

FIG. 25B is a view showing a wave front aberration occurring and amplified in the conventional optical isolator.

### DETAILED DESCRIPTION OF THE PREFERRED EMBODIMENTS

Embodiments of the present invention will now be described with reference to the accompanying drawings.

Embodiment 1

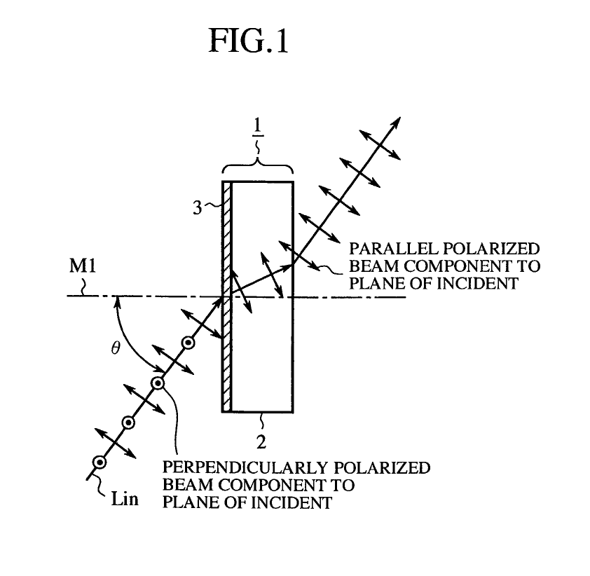

FIG. 1 is a view showing the configuration of a dielectric multi-layer thin film filter applied for an optical isolator according to a first embodiment of the present invention.

In FIG. 1, 1 indicates a dielectric multi-layer thin film filter. 2 indicates a light transmitting medium such as an optical glass BK7 formed in a plane parallel plate shape. 3 indicates a dielectric multi-layer thin film arranged on a surface of the light transmitting medium 2 on which a laser beam is incident. A thickness of the light transmitting medium 2 is set so as to set a thickness of the dielectric multi-layer thin film filter 1 to a maximum of 0.5 mm. Also, M1 indicates a line normal to the surface of the light transmitting medium 2 formed in the parallel plate shape. Lin indicates a laser beam incident on the dielectric multi-layer thin film filter 1. θ indicates an inclined placement angle (or a prescribed rotation angle) between the normal line M1 of the light transmitting medium 2 and a propagating path of the laser beam Lin, and the inclined placement angle θ denotes an angle of incidence of the laser beam Lin on the light transmitting medium 2.

The dielectric multi-layer thin film 3 of the dielectric multi-layer thin film filter 1 functions as a long wavelength transmission type filter for the laser beam Lin which is incident on the dielectric multi-layer thin film filter 1 while inclining the propagation direction of the laser beam Lin with respect to the normal line M1 of the dielectric multi-layer thin film filter 1. In detail, in the dielectric multi-layer thin film 3, a plurality of films formed of a low refractive index type substance (for example, SiO₂) and a plurality of films formed of a high refractive index type substance (for example, TiO₂) are layered so as to place each film of the low refractive index type substance between the two films of the high refractive index type substance, and the thickness of each film is adjusted so as to make a reflection bandwidth for a parallel polarized light component (hereinafter, called a P-polarized component) to the plane of incident in the laser beam Lin be narrower than that for a perpendicularly polarized light component (hereinafter, called an S-polarized component) in the laser beam Lin.

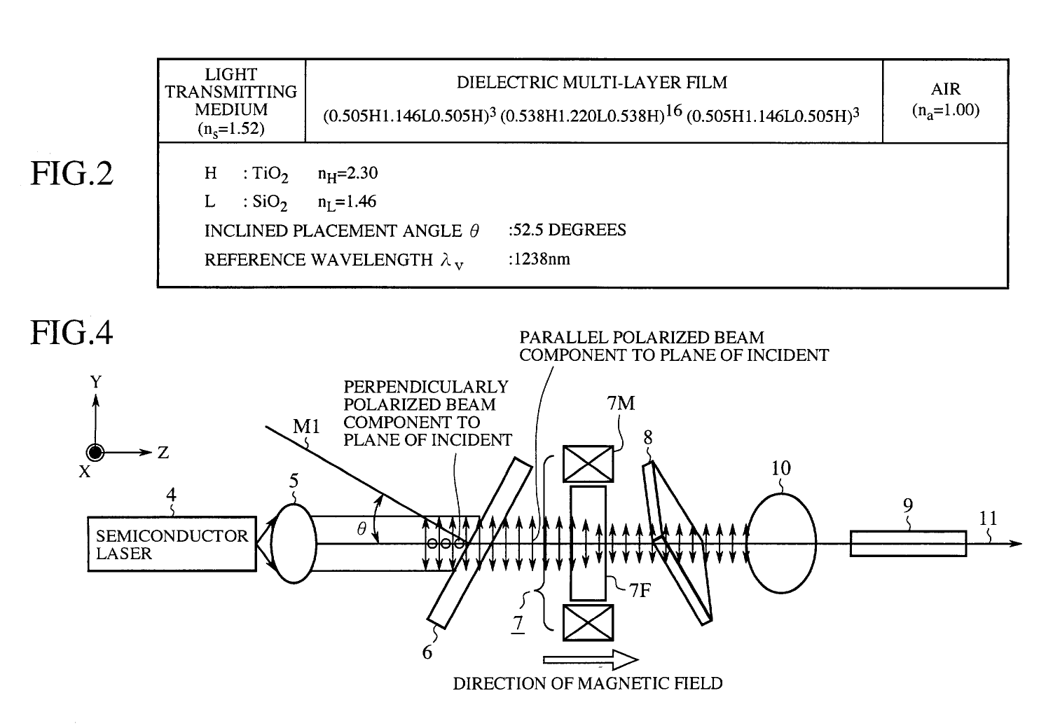

FIG. 2 shows a film thickness of the low refractive index type substance, a film thickness of the high refractive index type substance and the arrangement of the film of the low refractive index type substance placed between the two films of the high refractive index type substance in the dielectric multi-layer thin film 3 as an example.

In FIG. 2, n_{S}, n_{H}, n_{L} and n_{A} denote a refractive index of a substrate, a refractive index of a high refractive index type substance, a refractive index of a low refractive index type substance and a refractive index of air respectively. The high refractive index type substance is formed of TiO₂, and the low refractive index type substance is formed of SiO₂. A refractive index n_{H} of the high refractive index type substance (TiO₂) is equal to 2.30, and a refractive index n_{L} of the low refractive index type substance (SiO₂) is equal to 1.46.

A reference wavelength is set to λv=1238 nm denoting a wavelength of light passing through the vacuum, and the inclined placement angle θ=52. 5 degree is set. The reference wavelength λv has reference to a thickness of the high refractive index type substance (or the low refractive index type substance). That is, a length of the high refractive index type substance (or the low refractive index type substance) corresponding to one wavelength is expressed by λV/n_{H} (or λV/n_{L}).

Also, the symbol “H” indicates a length obtained by dividing a quarter (¼λv) of the reference wavelength by the refractive index n_{H} of the high refractive index type substance (H=λv/(4n_{H})), and the symbol “L” indicates a length obtained by dividing a quarter (¼λv) of the reference wavelength by the refractive index n_{L} of the low refractive index type substance (L=λv/(4n_{L})). Also, “(0.505H1.146L0.505H)” indicates that one film of the low refractive index type substance is placed between two films of the high refractive index type substance, the film thickness of the low refractive index type substance is equal to 1.146×λv/(4×n_{L}), and each film thickness of the high refractive index type substance is equal to 0.505×λv/(4×n_{H}). In this case, because the film thickness depends on the reference wavelength, the film thickness is changeable according to filter characteristics. Also, “(0.505H1.146L0.505H)” indicates that three films indicated by “(0.505H1.146L0.505H)” are repeatedly arranged in series three times. Therefore, 66 (=3×3+3×16+3×3) films are layered in the dielectric multi-layer thin film 3 so as to place each film of the low refractive index type substance between the two films of the high refractive index type substance.

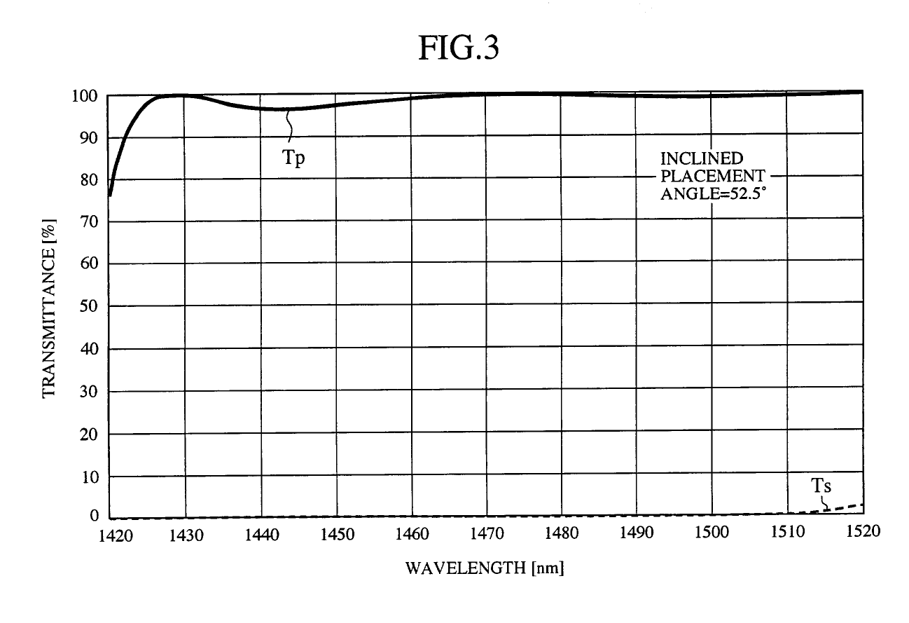

FIG. 3 shows transmission characteristics of the dielectric multi-layer thin film filter 1 having the dielectric multi-layer thin film 3 shown in FIG. 2 for both the P-polarized component and the S-polarized component of the laser beam.

In FIG. 3, an X-axis denotes a wavelength (in nanometer unit) of the laser beam Lin incident on the dielectric multi-layer thin film filter 1, and a Y-axis denotes a transmittance (%) of light in the dielectric multi-layer thin film filter 1. In this case, the inclined placement angle θ=52. 5 degree is set. As is shown by a dotted line in FIG. 3, the transmittance Ts of the S-polarized component of the laser beam Lin in the dielectric multi-layer thin film filter 1 is lower than several percentages. In contrast, as is shown by a solid line, the transmittance Tp of the P-polarized component of the laser beam Lin in the dielectric multi-layer thin film filter 1 is higher than 75 percentages. Therefore, the dielectric multi-layer thin film filter 1 has a high polarized wave separating characteristic so as to separate the P-polarized component and the S-polarized component from each other.

The configuration of an optical isolator using the dielectric multi-layer thin film filters 1 will be described below.

FIG. 4 is a view showing the configuration of an optical isolator according to the first embodiment of the present invention.

In FIG. 4, 4 indicates a semiconductor laser (or a laser beam source) configured to radiate a laser beam. the propagation direction of the laser beam is defined as a Z direction. 5 indicates a collimator lens (or a beam collimator) configured to collimate the laser beam radiated from the semiconductor laser 4. 6 indicates a polarizer (or a parallel-plate polarizer) formed of the dielectric multi-layer thin film filter 1. The dielectric multi-layer thin film 3 of the dielectric multi-layer thin film filter 1 is placed on a beam entrance side of the polarizer 6. The polarizer 6 has both a beam entrance plane and a beam outgoing plane parallel to each other, and a plane perpendicular to both the beam entrance plane and the beam outgoing plane of the polarizer 6 is defined as an Y-Z plane, and both the beam entrance plane and the beam outgoing plane of the polarizer 6 extend in an X direction perpendicular to the Y-Z plane. The laser beam is polarized in a direction in the polarizer 6, and a plane determined by both the polarization direction of the laser beam and the propagation direction of the laser beam is called a polarization plane of the laser beam.

7 indicates a Faraday rotator (or a rotator) composed of a Faraday effect element 7F and a magnet 7M arranged on the Faraday effect element 7F. 11 indicates the optical axis of the Faraday rotator 7. Both a beam entrance plane and a beam outgoing plane of the Faraday effect element 7F are respectively perpendicular to the optical axis 11 directed in the Z direction. The Faraday rotator 7 has a rotatory function of polarization on the optical axis 11. That is to say, the Faraday rotator 7 has an optical rotation function so as to rotate the polarization plane of the laser beam incident on the Faraday rotator 7 on the optical axis 11 of the Faraday rotator 7 by a prescribed rotation angle of 45 degrees in cooperation with the magnetic field of the magnet 7M.

8 indicates an analyzer (or a parallel-plate analyzer) formed of the dielectric multi-layer thin film filter 1. The analyzer 8 has a beam entrance plane and a beam outgoing plane parallel to each other, and the dielectric multi-layer thin film 3 of the dielectric multi-layer thin film filter 1 is placed on the beam entrance side of the analyzer 8. The analyzer 8 is placed across the Faraday rotator 7 from the polarizer 6.

9 indicates an optical fiber (or a beam transmitting unit) through which the laser beam transmitted through the polarizer 6, the Faraday rotator 7 and the analyzer 8 in that order is transmitted. 10 indicates a coupling lens (or an optical coupling unit) configured to couple the laser beam output from the analyzer 8 to the optical fiber 9. The polarizer 6 and the analyzer 8 cross the optical axis 11 of the Faraday rotator 7. Here, because the laser beam transmitting along the optical axis 11 is refracted in the polarizer 6 and the analyzer 8, the laser beam is shifted from the optical axis 11. However, because a shift degree of the laser beam from the optical axis 11 is very low, the laser beam is shown in FIG. 4 so as to be always placed on the optical axis 11 of the Faraday rotator 7.

The polarizer 6 formed of the dielectric multi-layer thin film filter 1 is arranged so as to be inclined with respect to the optical axis 11 of the Faraday rotator 7 by the inclined placement angle θ. In other words, the polarizer 6 is placed by rotating the polarizer 6 perpendicular to the optical axis 11 by the inclined placement angle θ on a rotation axis directed in the X direction. In cases where the polarizer 6 has the dielectric multi-layer thin film 3 shown in FIG. 2, the inclined placement angle θ is set to a value ranging from 50 to 60 degrees around a Brewster angle (56.7 degrees). Also, a polarization direction (hereinafter, called a first polarization direction) agreeing with the Y direction perpendicular to the optical axis 11 is set in the polarizer 6 according to a polarized beam transmission characteristic of the polarizer 6. Therefore, the laser beam incident on the polarizer 6 is linearly polarized in the first polarization direction of the polarizer 6. In other words, the P-polarized component of the laser beam polarized in the first polarization direction is transmitted through the polarizer 6, but the S-polarized component of the laser beam polarized in the X direction is reflected on the polarizer 6. A plane determined by both the first polarization direction of the P-polarized component transmitted through the polarizer 6 and the propagation direction of the laser beam agreeing with the Z direction is called a first polarization plane of the laser beam. The first polarization plane agrees with the Y-Z plane.

The analyzer 8 formed of the dielectric multi-layer thin film filter 1 is placed by inclining the analyzer 8 perpendicular to the optical axis 11 by the inclined placement angle θ in a direction opposite to that of the inclination of the polarizer 6 with respect to the optical axis 11 of the Faraday rotator 7 and rotating the analyzer 8 having the same polarization direction as that of the polarizer 6 on the optical axis 11 by a rotation angle of 45 degrees. The rotation angle of 45 degrees agrees with the prescribed rotation angle of the Faraday rotator 7. Therefore, a polarization direction (hereinafter, called a-second polarization direction) of the analyzer 8 set according to a polarized beam transmission characteristic of the analyzer 8 agrees with a direction inclined from the Y direction toward the X direction by 45 degrees. The laser beam incident on the analyzer 8 is linearly polarized in the second polarization direction of the analyzer 8. In other words, the P-polarized component of the laser beam polarized in the second polarization direction is transmitted through the analyzer 8, but the S-polarized component of the laser beam polarized in the direction perpendicular to the second polarization direction is reflected on the analyzer 8. A plane determined by both the second polarization direction of the P-polarized component transmitted through the analyzer 8 and the propagation direction of the laser beam agreeing with the Z direction is called a second polarization plane of the laser beam. The second polarization plane agrees with a plane obtained by inclining the Y-Z plane toward the X-Z plane by 45 degrees.

An optical isolator according to the first embodiment comprises the polarizer 6, the Faraday rotator 7 and the analyzer 8.

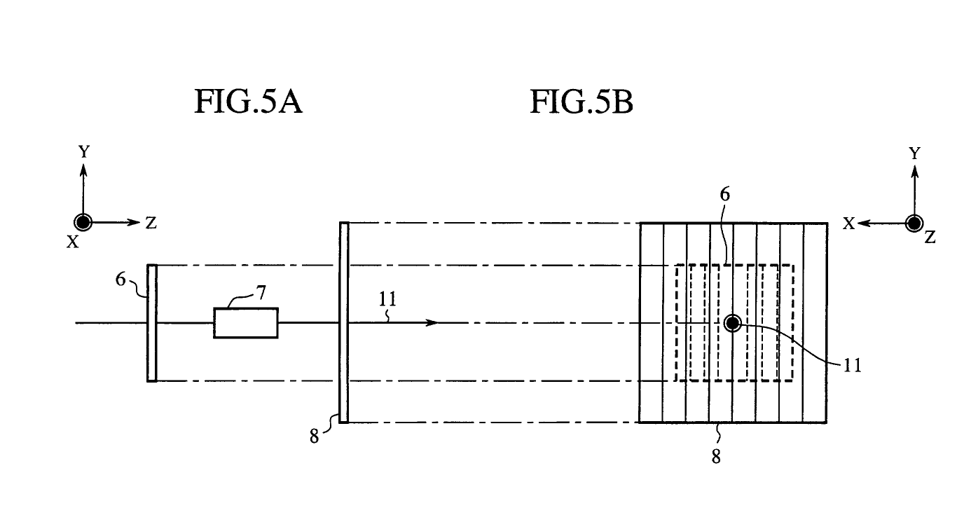

The layout of the polarizer 6 and the analyzer 8 will be described with reference to FIG. 5 to FIG. 8.

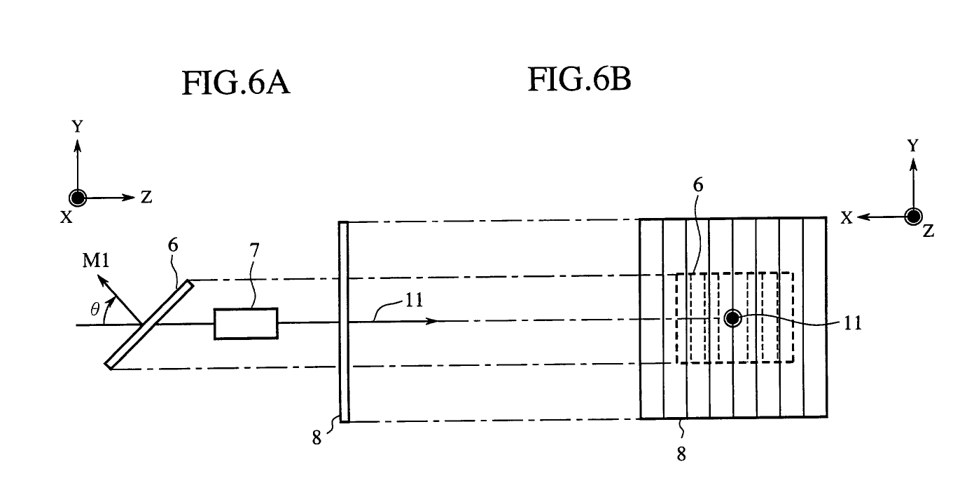

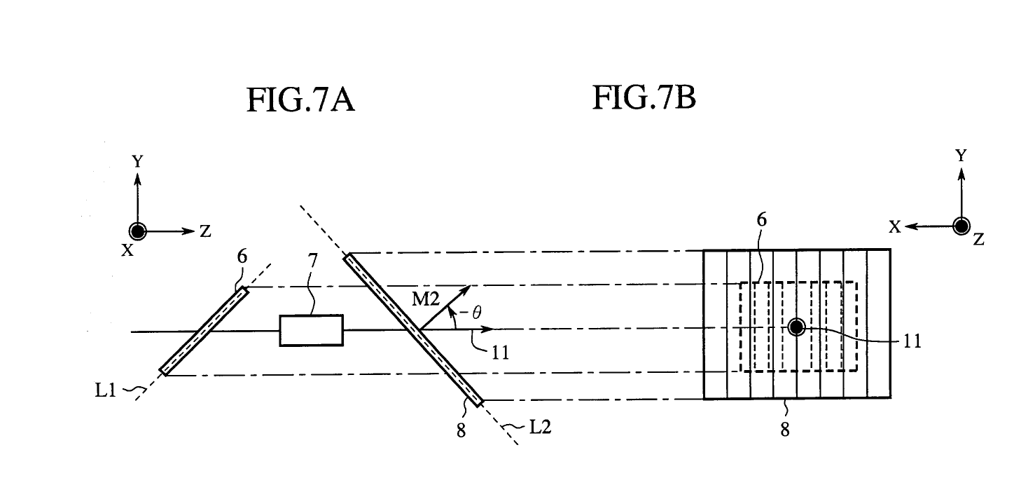

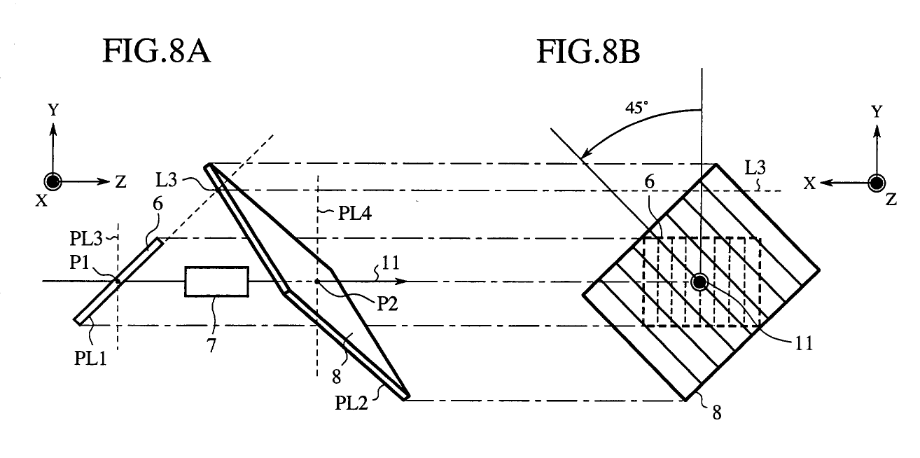

FIG. 5A to FIG. 8B are schematic views of the optical isolators showing the procedure for a layout of the polarizer 6 and the analyzer 8. FIG. 5A, FIG. 6A, FIG. 7A and FIG. 8A are respectively a side view of the optical isolator seen from the X direction. FIG. 5B, FIG. 6B, FIG. 7B and FIG. 8B are respectively a front view of the optical isolator seen from the Z direction.

In a first step shown in FIG. 5A and FIG. 5B, the plate surfaces of the polarizer 6 and the analyzer 8 are perpendicular to the optical axis 11 of the Faraday rotator 7. Therefore, the polarization directions of the polarizer 6 and the analyzer 8 agree with the Y direction.

In a second step, the polarizer 6 is rotated in a rotation direction on a rotation axis which is parallel to the X direction and penetrates though the center of the polarizer 6 by the rotation angle θ. Therefore, as shown in FIG. 6A and FIG. 6B, the angle between the normal line M1 of the polarizer 6 and the optical axis 11 of the Faraday rotator 7 is set to the inclined placement angle θ. In cases where the inclined placement angle θ is set to a value ranging from 50 to 60 degrees around the Brewster angle (56.7 degrees), the polarized wave separating characteristic of the polarizer 6 is improved.

In a third step, the analyzer 8 is rotated in a rotation direction opposite to that of the polarizer 6 on a rotation axis which is parallel to the X direction and penetrates though the center of the analyzer 8 by the rotation angle θ. Therefore, as shown in FIG. 7A and FIG. 7B, the angle between a normal line M2 of the analyzer 8 and the optical axis 11 of the Faraday rotator 7 is set to the inclined placement angle −θ, and the inclination of the analyzer 8 with respect to the optical axis 11 is opposite to that of the polarizer 6 in the Y-Z plane. In other words, an intersection line L1 between the polarizer 6 and the first polarization plane (or the Y-Z plane) intersects to an intersection line L2 between the analyzer 8 and a polarization plane (or the Y-Z plane) of the laser beam transmitting through the analyzer 8 in a V shape.

In a final step, the analyzer 8 is rotated on the optical axis 11 of the Faraday rotator 7 by 45 degrees so as to shift the second polarization plane of the analyzer 8 for the laser beam from the first polarization plane (or the Y-Z plane) by 45 degrees. Therefore, as shown in FIG. 8A and FIG. 8B, the polarization direction of the analyzer 8 is rotated on the optical axis 11 of the Faraday rotator 7 by 45 degrees so as to agree with the second polarization direction, and the P-polarized component of the laser beam rotated in the Faraday rotator 7 by 45 degrees can be transmitted through the analyzer 8 almost without attenuation. The layout of the polarizer 6 and the analyzer 8 shown in FIG. 8A and FIG. 8B agrees with that shown in FIG. 4.

The layout of the polarizer 6 and the analyzer 8 shown in FIG. 8A and FIG. 8B can be also expressed as follows. A first plane PL1 including a beam outgoing plane of the polarizer 6, a second plane PL2 including a beam entrance plane of the analyzer 8, a third plane PL3 including an intersection P1 of the first plane PL1 and the optical axis 11 and being perpendicular to the optical axis 11 and a fourth plane PL4 including an intersection P2 of the second plane and the optical axis 11 and being perpendicular to the optical axis 11 are obtained, and the layout of the polarizer 6 and the analyzer 8 is determined so as to make an intersection line L3 of the first plane PL1 and the second plane PL2 pass between the third plane PL3 and the fourth plane PL4.

The layout of the polarizer 6 and the analyzer 8 shown in FIG. 8A and FIG. 8B can be also expressed as follows. The analyzer 8 shown in FIG. 6 is placed as an imaginary analyzer 8 so as to be parallel to an imaginary polarizer 6 inclined at the inclined placement angle θ. In other words, the imaginary analyzer 8 is inclined by the inclined placement angle θ on a rotation axis parallel to the X axis in the same manner as the imaginary polarizer 6. In this case, the imaginary analyzer 8 is placed so as to make a polarization direction of the imaginary analyzer 8 be parallel to a polarization direction of the imaginary polarizer 6. Thereafter, the imaginary analyzer 8 is rotated by 180 degrees on the optical axis of an imaginary Faraday rotator 7 in a direction of rotation of the imaginary Faraday rotator 7. The direction of rotation of the imaginary Faraday rotator 7 denotes a rotation direction that a polarization plane of a polarized laser beam transmitted through the imaginary Faraday rotator 7 in a direction of a magnetic field is rotated. As a result, the arrangement of the imaginary polarizer 6 and the imaginary analyzer 8 is obtained on condition that the arrangement of the imaginary polarizer 6 and the imaginary analyzer 8 is the same as that of the polarizer 6 and the analyzer 8 shown in FIG. 7. Thereafter, the imaginary analyzer 8 is further rotated by 45 degrees on the optical axis of the imaginary Faraday rotator 7 in the direction of rotation of the imaginary Faraday rotator 7. Therefore, as a result, the imaginary analyzer 8 is rotated by 225 degrees on the optical axis of the imaginary Faraday rotator 7 in the direction of rotation of the imaginary Faraday rotator 7. In this case, the arrangement of the imaginary polarizer 6 and the imaginary analyzer 8 is obtained on condition that the arrangement of the imaginary polarizer 6 and the imaginary analyzer 8 is the same as that of the polarizer 6 and the analyzer 8 shown in FIG. 8.

This arrangement process is one example. For example, it is applicable that the analyzer 8 be rotated by 135 degrees on the optical axis of the Faraday rotator 7 in a direction opposite to the direction of rotation of the Faraday rotator 7. In this case, the same arrangement of the polarizer 6 and the analyzer 8 can be obtained.

In detail, an optical isolator according to the first embodiment is characterized by the Faraday rotator 7 having the optical axis 11, the parallel-plate polarizer 6 crossing the optical axis 11 and disposed on one side of the Faraday rotator 7 and the parallel-plate analyzer 8 crossing the optical axis 11 and disposed on the other side of the Faraday rotator 7. In this case, as a result, the polarizer 6, the analyzer 8 and the Faraday rotator 7 have substantially the same arrangement as that of an imaginary polarizer, an imaginary analyzer and an imaginary Faraday rotator arranged according to following steps (step 1 , step 2 and step 3). The imaginary analyzer is placed in a perpendicular relationship to an optical axis of the imaginary Faraday rotator, and the imaginary polarizer is placed so as to make a first polarization plane of a polarized laser beam allowed to be transmitted through the imaginary polarizer be parallel with a second polarization plane of a polarized laser beam allowed to be transmitted through the imaginary analyzer (step 1). Thereafter, the imaginary polarizer and the imaginary analyzer are tilted to each other with respect to the optical axis of the imaginary Faraday rotator so as to make a first intersection line of the imaginary polarizer and the first polarization plane face a second intersection line of the imaginary analyzer and the second polarization plane in an almost V shape (step 2). Thereafter, the imaginary analyzer is rotated on the optical axis of the imaginary Faraday rotator so as to make the first polarization plane incline at an angle of about 45 degrees with respect to the second polarization plane (step 3). Thereafter, a rotation angle of the imaginary Faraday rotator is set at about 45 degrees by which a polarization plane of a polarized laser beam rotates on the optical axis.

Therefore, the arrangement process is not limited on condition that the arrangement of the polarizer 6 and the analyzer 8 shown in FIG. 8 is obtained, and the imaginary polarizer 6, the imaginary Faraday rotator 7 and the imaginary analyzer 8 are merely used to describe the arrangement process. In other words, the arrangement process described above does not limit a production process of the optical isolator.

The first embodiment is not limited to the procedure shown in FIG. 5A to FIG. 8B, and any procedure for obtaining the layout shown in FIG. 8A and FIG. 8B is available. Also, in the first embodiment, to easily realize the procedure for obtaining the layout of the polarizer 6 and the analyzer 8, the beam entrance plane and the beam outgoing plane of each of the polarizer 6 and the analyzer 8 are respectively formed in a square shape, and the size of the analyzer 8 is larger than that of the polarizer 6. However, the size and shape of each of the polarizer 6 and the analyzer 8 can be arbitrary set on condition that the laser beam radiated from the semiconductor laser 4 is not transmitted through the outside of the polarizer 6 or the analyzer 8.

Next, an operation of the optical isolator will be described below.

As shown in FIG. 4, the laser beam radiated from the semiconductor laser 4 is converted into a collimated laser beam in the collimator lens 5 and is transmitted along the optical axis 11 of the Faraday rotator 7, and the collimated laser beam is incident on the polarizer 6. Because the polarizer 6 is inclined with respect to the optical axis 11 of the Faraday rotator 7 by the inclined placement angle θ, the laser beam transmitted along the optical axis 11 is incident on the polarizer 6 at an angle θ of incident.

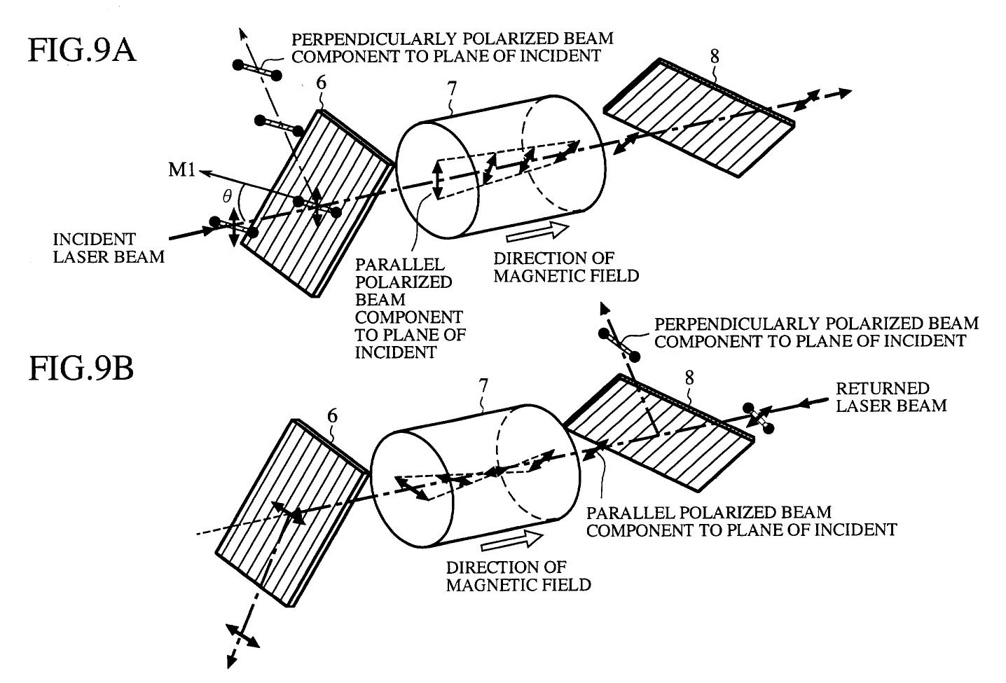

FIG. 9A shows a view of the laser beam transmitted forward through the optical isolator, and FIG. 9B shows a view of the laser beam transmitted backward through the optical isolator.

In FIG. 9A, the laser beam radiated from the semiconductor laser 4 to the optical isolator is a beam linearly polarized at a polarization extinction ratio of about 20 dB. The P-polarized component of the linearly polarized laser beam polarized in the first polarization direction of the polarizer 6 is transmitted through the polarizer 6 at a high transmittance, and the S-polarized component of the linearly polarized laser beam polarized in a polarization direction perpendicular to the first polarization direction of the polarizer 6 is reflected on the polarizer 6. Thereafter, the P-polarized component of the laser beam shown by an electric field vector directed in the first polarization direction is rotated on the optical axis 11 of the Faraday rotator 7 in a rotation direction by 45 degrees in the Faraday rotator 7, and the rotated P-polarized component of the laser beam is incident on the analyzer 8. Because the second polarization direction of the analyzer 8 makes an angle of almost 45 degrees with the first polarization direction of the polarizer 6, the polarization direction of the P-polarized component of the laser beam rotated in the Faraday rotator 7 agrees with the second polarization plane of the analyzer 8. Therefore, the P-polarized component of the laser beam rotated in the Faraday rotator 7 is transmitted through the analyzer 8 at a high transmittance. Thereafter, as shown in FIG. 4, the laser beam transmitted through the analyzer 8 is coupled to the optical fiber 9 through the coupling lens 10.

Also, a part of the laser beam transmitted through the analyzer 8 is reflected on the optical fiber 9 and/or the coupling lens 10 and is returned to the analyzer 8 as a returned laser beam. Therefore, as shown in FIG. 9B, an S-polarized component of the returned laser beam is reflected on the dielectric multi-layer thin film 3 of the analyzer 8, and a P-polarized component of the returned laser beam is transmitted backward through the analyzer 8. Thereafter, the P-polarized component transmitted through the analyzer 8 is rotated on the optical axis 11 of the Faraday rotator 7 in the rotation direction by 45 degrees in the Faraday rotator 7. The rotation direction for the returned laser beam transmitted backward is the same as that for the laser beam transmitted forward. Therefore, the polarization direction of the P-polarized component of the returned laser beam rotated in the Faraday rotator 7 is perpendicular to the first polarization direction of the polarizer 6. In this case, the returned laser beam rotated in the Faraday rotator 7 is incident on the polarizer 6 as an S-polarized component, and the returned laser beam is reflected on the polarizer 6. Therefore, no returned laser beam is incident on the semiconductor laser 4. That is to say, the semiconductor laser 4 is isolated from the returned laser beam by the optical isolator.

Next, the reduction of a wave front aberration occurring in the laser beam will be described below.

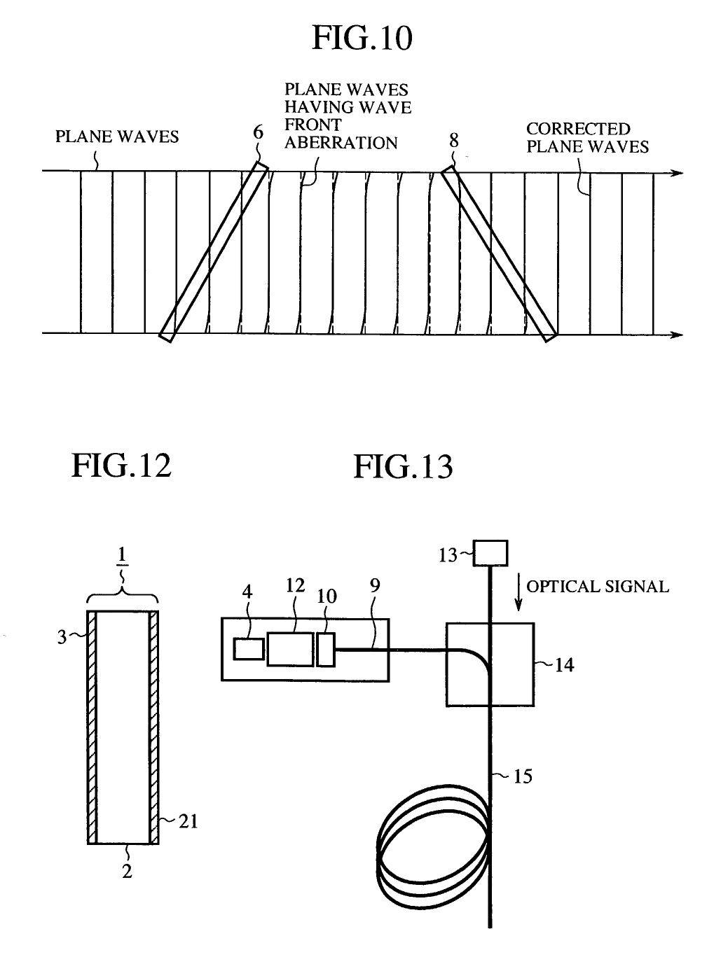

FIG. 10 is a conceptual view showing the reduction of a wave front aberration of incident waves obtained in the optical isolator according to the first embodiment of the present invention.

The laser beam transmitted through the polarizer 6, the Faraday rotator 7 and the analyzer 8 can be conceptually replaced with a plurality of incident waves propagating through the polarizer 6, the Faraday rotator 7 and the analyzer 8. In this case, because the Faraday rotator 7 is arranged so as to be parallel to wave fronts of the incident waves, no influence is exerted by the Faraday rotator 7 on the wave front aberration of the incident waves. Therefore, the Faraday rotator 7 is not shown in FIG. 10.

As shown in FIG. 10, the inclination of the analyzer 8 with respect to the wave fronts of the incident waves (or the optical axis 11 of the Faraday rotator 7) is opposite to that of the polarizer 6. Therefore, the wave front aberration of the incident waves caused by the polarizer 6 is cancelled out and corrected in the analyzer 8, and the wave front aberration of the incident waves caused by the polarizer 6 is considerably reduced in the analyzer 8. Accordingly, the laser beam, of which the wave front aberration is considerably reduced, can be output from the optical isolator.

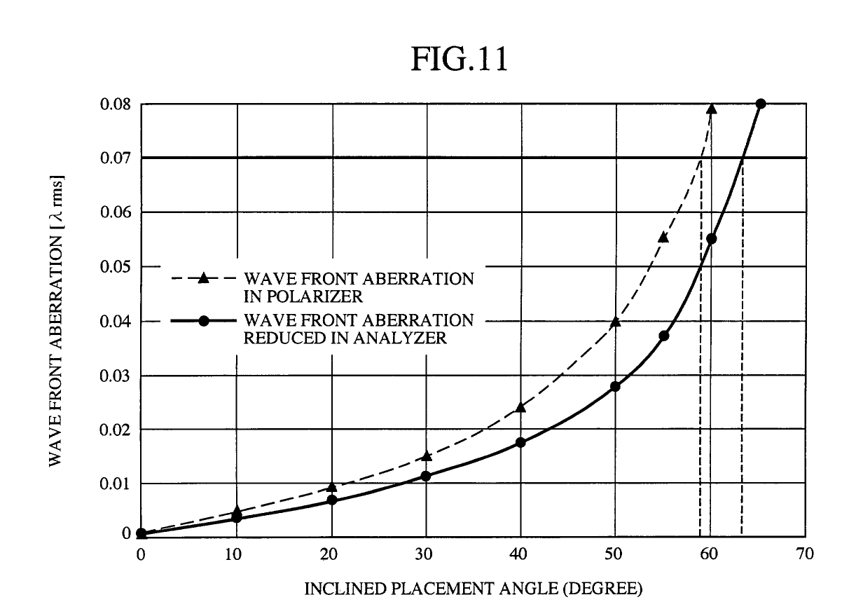

FIG. 11 is a view showing the relationship between the inclined placement angle and the reduction of the wave front aberration. The polarizer 6 and the analyzer 8 are respectively formed of a parallel plate having a thickness of 0.5 mm.

In FIG. 11, the X-axis expresses the inclined placement angle θ of the polarizer 6. The Y-axis expresses the wave front aberration occurring to the laser beam set to the wavelength of 1480 nm. Therefore, the dependence of the wave front aberration on the inclined placement angle of the polarizer 6 is shown in FIG. 11. A wave front aberration caused by the polarizer 6 is expressed by a dotted curved line. A wave front aberration reduced in the analyzer 8 is expressed by a solid curved line.

In this embodiment, the polarizer 6 and the analyzer 8 are disposed so as to be opposite to each other through the Faraday rotator 7, the polarizer 6 is inclined with respect to the optical axis 11, the analyzer 8 is inclined in the direction opposite to that of the inclination of the polarizer 6, and the inclined placement angle θ of the polarizer 6 (or the analyzer 8) is set to a value ranging from 50 to 60 degrees around the Brewster angle (56.7 degrees). Therefore, as is apparently shown in FIG. 11, the wave front aberration occurring to the laser beam in the polarizer 6 can be reduced in the analyzer 8.

An intensity of the laser beam having the wave front aberration at a position A is expressed according to an equation (1).

i(A)=1−(2π/λ)²×(ΔΦ)² (1)

Here, i(A) denotes a normalized intensity of the laser beam. λ denotes the wavelength of the laser beam. λΦ denotes a degree of the wave front aberration.

In cases where the normalized intensity i(A) of the laser beam is equal to or higher than 0.8, it is judged that the wave front aberration of the laser beam is sufficiently reduced. When the degree λΦ of the wave front aberration is equal to or lower than λ/14 (≈0.07λ), the normalized intensity i(A) is equal to or higher than 0.8. Therefore, as shown in FIG. 11, the inclined placement angle θ has an upper limit of about 60 degrees.

In the first embodiment, the analyzer 8 is placed across the Faraday rotator 7 from the polarizer 6 having the same optical characteristic as that of the analyzer 8, the inclined placement angle θ of the polarizer 6 is set to a value ranging from 50 to 60 degrees around the Brewster angle (56.7 degrees) so as to be lower than the upper limit, and the inclination of the analyzer 8 is set to be opposite to that of the polarizer 6. Therefore, as is apparent in FIG. 11, the wave front aberration of the laser beam caused by the polarizer 6 can be reduced in the analyzer 8.

Also, in the first embodiment, the absolute inclined placement angle θ of the polarizer 6 agrees with that of the analyzer 8. However, even though there is a difference between the absolute inclined placement angle θ of the polarizer 6 and the absolute inclined placement angle θ of the analyzer 8, the wave front aberration can be reduced in the optical isolator to some degree.

Also, in the first embodiment, each of the polarizer 6 and the analyzer 8 is formed of the dielectric multi-layer thin film filter 1, and the light transmitting medium 2 of the dielectric multi-layer thin film filter 1 is formed of the optical glass BK7 of a plane parallel thin plate. Therefore, the thickness of the light transmitting medium 2 can be easily set to a value lower than 1 mm. In particular, to prevent the light transmitting medium 2 from being distorted in the deposition of the dielectric multi-layer thin film 3, it is required that the thickness of the light transmitting medium 2 is equal to or larger than 0.2 mm. Also, to reduce the wave front aberration of the laser beam caused by the light transmitting medium 2, it is preferred that that the thickness of the light transmitting medium 2 is equal to or smaller than 0.5 mm. Therefore, the thickness of the light transmitting medium 2 is set in a range from 0.2 mm to 0.5 mm, and the wave front aberration of the laser beam can be reliably reduced in the optical isolator as compared with a case where a polarization beam splitter having a large thickness is used for the polarizer 6 or the analyzer 8.

Also, in the polarization beam splitter, a thin film placed between two high refractive index type substances is attached to the two high refractive index type substances by using binding material. Therefore, assuming that the polarization beam splitter is used as the polarizer 6 or the analyzer 8, there is a probability that the transmittance of the polarizer 6 or the analyzer 8 deteriorates due to the heat deterioration of the binding material. However, in the first embodiment, the polarization beam splitter is not used for the polarizer 6 or the analyzer 8, but the dielectric multi-layer thin film 3 is arranged on the light transmitting medium 2 according to an oxygen ion assisted electron beam deposit or an oxygen plasma assisted electron beam deposit. Therefore, no binding material is used for the dielectric multi-layer thin film filter 1, and the transmittance of the polarizer 6 or the analyzer 8 does not deteriorate.

Also, in the first embodiment, the dielectric multi-layer thin film filter 1 functions as a long wavelength transmission type filter for the laser beam by placing each film of the low refractive index type substance (for example, SiO₂) between the two films of the high refractive index type substance (for example, TiO₂) in the dielectric multi-layer thin film 3. Therefore, because the number of films in the dielectric multi-layer thin film 3 is smaller than that of a short wavelength transmission type filter in which each of films of the high refractive index type substance is placed between the two films of the low refractive index type substance, the thickness of the dielectric multi-layer thin film 3 can be thinned. Accordingly, the wave front aberration of the laser beam can be reduced, and the material cost of the polarizer 6 and the analyzer 8 can be reduced. Also, even though the thermal stress occurs in the polarizer 6 and/or the analyzer 8, the distortion of the dielectric multi-layer thin film 3 can be reduced. Also, the formation time of the dielectric multi-layer thin film 3 can be shortened, and the dielectric multi-layer thin film 3 can be easily formed.

Also, in the first embodiment, the dielectric multi-layer thin film 3 is placed on the light transmitting medium 2 according to an oxygen ion assisted electron beam deposit or an oxygen plasma assisted electron beam deposit to form a thin-film type polarizing filter. Therefore, the film thickness of the dielectric multi-layer thin film 3 can be correctly adjusted so as to transmit only the laser beam having a predetermined wavelength, and the dielectric multi-layer thin film 3 can be formed in a mechanically strong structure so as to prevent the dielectric multi-layer thin film 3 from being damaged due to the use environment of the optical insulator.

Also, in the first embodiment, as shown in FIG. 12, it is preferred that an antireflection film 21 is formed on a plane of the light transmitting medium 2 opposite to the plane on which the dielectric multi-layer thin film 3 is arranged. The antireflection film 21 is placed on both a beam outgoing side of the polarizer 6 and a beam outgoing side of the analyzer 8. In this case, even though the returned laser beam transmitted backward is incident on the polarizer 6 or the analyzer 8, the returned laser beam is reflected on the antireflection film 21 of the polarizer 6 or the analyzer 8. Therefore, noise occurring in the laser beam radiated from the semiconductor laser 4 due to the returned laser beam can be reduced.

Also, in the first embodiment, the inclined placement angle θ of both the polarizer 6 and the analyzer 8 is set to a value ranging from 50 to 60 degrees. However, it is preferable that the inclined placement angle θ be set to the Brewster angle. In cases where the light transmitting medium 2 is, for example, formed of the optical glass BK7, the inclined placement angle θ is set to the Brewster angle of 56.7 degrees. In this case, even though no antireflection film is formed on the light transmitting medium 2, noise occurring in the laser beam radiated from the semiconductor laser 4 due to the returned laser beam can be reduced. Also, the manufacturing cost and the material cost of the dielectric multi-layer thin film filter 1 can be reduced.

Also, in the first embodiment, it is preferable that the optical isolator comprising the polarizer 6, the Faraday rotator 7 and the analyzer 8, the semiconductor laser 4, the collimator lens 5, the coupling lens 10 and a part of the optical fiber 9 be fixedly arranged in a box as a laser module. In this case, a laser module can be obtained on condition that noise occurring in the laser beam radiated from the semiconductor laser 4 due to the returned laser beam is reduced in the laser module.

Also, it is preferred that the laser module is used as an excited laser beam source for a light amplifier.

FIG. 13 is a schematic view showing the configuration of a light amplifier according to the first embodiment of the present invention. The light amplifier according to the first embodiment is called an erbium added optical fiber amplifier.

In FIG. 13, 12 indicate the optical isolator including the collimator lens 5 configured to output an excited laser beam in which noise caused by the returned laser beam is reduced. The excited laser beam is transmitted through the optical fiber 9. 13 indicates an optical signal input terminal (or an optical signal receiving unit) configured to receive an optical signal. 14 indicates an optical signal and excited beam coupler (or an optical signal and excited beam coupling unit) configured to couple the optical signal received in the optical signal input terminal 13 with the excited laser beam transmitted through the optical fiber 9. 15 indicates an erbium added optical fiber (or an optical signal amplifying path or a rare earth added optical fiber) configured to amplify the optical signal output from the optical signal and excited beam coupler 14 according to the excited laser beam. The erbium added optical fiber 15 is obtained by adding rare earth such as erbium in an optical fiber.

Because the semiconductor laser 4 is isolated from the returned laser beam transmitted backward by the function of the optical isolator 12 according to the first embodiment, a light amplifier having an excited laser beam source of low noise is obtained. Therefore, a low noise and high efficiency light amplifier can be obtained.

In the first embodiment, the erbium added optical fiber 15 is used. However, it is applicable that a rare earth added optical fiber obtained by adding rare earth other than erbium to an optical fiber be used in place of the erbium added optical fiber 15.

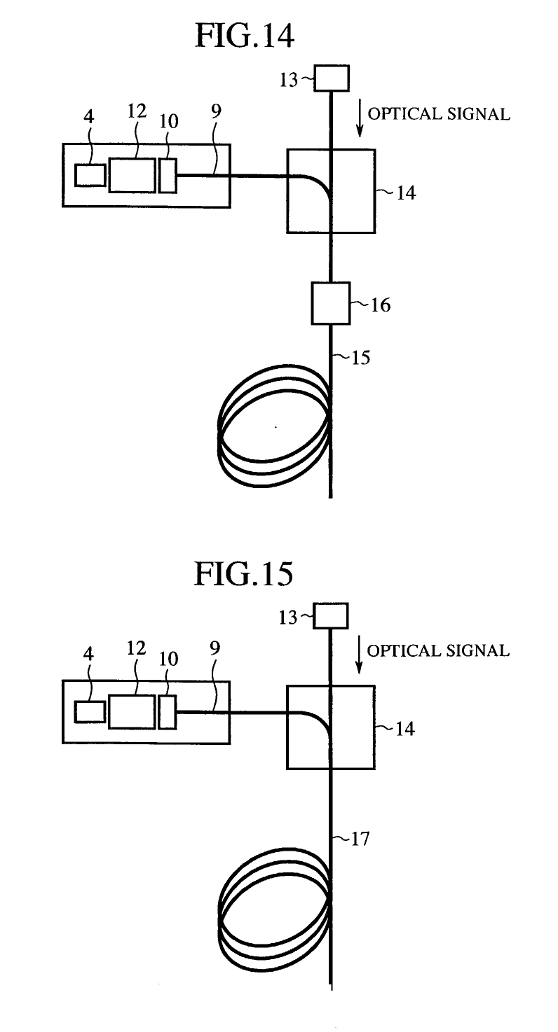

Also, in the first embodiment, it is applicable that the optical isolator according to the first embodiment be arranged on the input side, the output side or both the input and output sides of the erbium added optical fiber 15. For example, as shown in FIG. 14, a second optical isolator 16 according to the first embodiment is arranged on the input side of the erbium added optical fiber 15. In this case, the oscillation of the returned laser beam in the light amplifier can be prevented.

Also, in the first embodiment, as shown in FIG. 15, it is applicable that an optical fiber (or an optical signal amplifying path) 17 be used in place of the erbium added optical fiber 15 to apply the optical isolator 12 or 16 according to the first embodiment for a light amplifier using Raman amplification.

Here, it is applicable that the excitation direction of the optical signal be the forward excitation, the backward excitation or the bi-directional excitation.

As is described above, in the first embodiment, the optical isolator comprises the plane parallel plate polarizer 6 which is inclined by the inclined placement angle θ with respect to the optical axis 11 and is configured to receive the laser beam transmitted along the optical axis 11 and output a polarized component of the laser beam linearly polarized in the first polarization direction according to the polarized beam transmission characteristic, the Faraday rotator 7 configured to rotate the polarized component of the laser beam transmitted through the polarizer 6 on the optical axis 11, and the plane parallel plate analyzer 8 which is placed across the Faraday rotator 7 from the polarizer 6, is inclined by the inclined placement angle θ in a direction opposite to that of the inclination of the polarizer 6 with respect to the optical axis 11 of the Faraday rotator 7, and configured to receive the polarized component of the laser beam from the Faraday rotator 7 and outputting a polarized component of the laser beam linearly polarized in the second polarization direction according to the polarized beam transmission characteristic. Accordingly, because the wave front aberration of the laser beam caused by the polarizer 6 is cancelled out in the analyzer 8 inclined in the direction opposite to that of the inclination of the polarizer 6, the wave front aberration of the laser beam can be reduced.

Also, in the first embodiment, the polarizer 6 and the analyzer 8 are inclined so as to set the inclined placement angle θ between the normal line M1 or M2 of each of the polarizer 6 and the analyzer 8 and the optical axis 11 to the Brewster angle of 56.7 degrees. Therefore, even though no antireflection film is arranged on the polarizer 6 or the analyzer 8, the returned laser beam can be prevented from being incident on the semiconductor laser 4. Accordingly, the manufacturing cost and the material cost of the optical isolator can be reduced.

Also, in the first embodiment, the polarizer 6 and the analyzer 8 are inclined by the inclined placement angle θ with respect to the optical axis 11, and the inclined placement angle θ ranges from 50 to 60 degrees around the Brewster angle. Therefore, the P-polarization component of the laser beam can be transmitted through the polarizer 6 and the analyzer 8 at a high transmittance.

Also, in the first embodiment, the first polarization direction set according to the polarized beam transmission characteristic of the polarizer 6 makes an angle of 45 degrees with the second polarization direction of the analyzer 8, the polarized component of the laser beam transmitted through the polarizer 6 is rotated on the optical axis 11 by the rotation angle of 45 degrees in a rotation direction by the Faraday rotator 7 to make the polarization direction of the polarized component of the laser beam agree with the second polarization direction of the analyzer 8, and the polarized component of the laser beam linearly polarized in the second polarization direction is transmitted through the analyzer 8. Therefore, even though a returned laser beam is transmitted backward from the optical fiber 9 to the analyzer 8, a polarized component of the returned laser beam transmitted through the analyzer 8 is rotated on the optical axis 11 by 45 degrees in the rotation direction by the Faraday rotator 7, and the polarized component of the returned laser beam linearly polarized in a direction perpendicular to the first polarization direction of the polarizer 6 is incident on the polarizer 6. Accordingly, no returned laser beam is transmitted through the polarizer 6, and the semiconductor laser 4 can be appropriately isolated from the returned laser beam.

Also, in the first embodiment, the polarizer 6 and the analyzer 8 are respectively formed of the dielectric multi-layer thin film filter 1, the dielectric multi-layer thin film filter 1 is obtained by arranging the dielectric multi-layer thin-film 3 on one surface of the light transmitting medium 2 formed of a plane parallel plate, and the thickness of the light transmitting medium 2 is set so as to set a thickness of the dielectric multi-layer thin film filter 1 to a maximum of 0.5 mm. Therefore, the light transmitting medium 2 is thinned, and the wave front aberration of the laser beam caused by the light transmitting medium 2 can be reduced.

Also, in the first embodiment, the dielectric multi-layer thin film 3 is attached to one surface of the light transmitting medium 2 without using any binding material, and the dielectric multi-layer thin film filter 1 is used as each of the polarizer 6 and the analyzer 8. Therefore, the thermal deterioration of the polarizer 6 or the analyzer 8 does not occur, and the transmittance of the laser beam in the optical isolator is not lowered.

Also, in the first embodiment, the dielectric multi-layer thin film 3 is arranged on one surface of the light transmitting medium 2 formed of a plane parallel plate according to the oxygen ion assisted electron beam deposit or the oxygen plasma assisted electron beam deposit. Therefore, the dielectric multi-layer thin film 3 can be formed in a mechanically strong structure so as to prevent the dielectric multi-layer thin film 3 from being damaged due to the use environment of the optical insulator. Also, the precision in the formation of the dielectric multi-layer thin film 3 can be improved, and only the laser beam having the predetermined wavelength can be transmitted through the optical isolator.

Also, in the first embodiment, the antireflection film 21 is formed on a plane of the light transmitting medium 2 opposite to the plane on which the dielectric multi-layer thin film 3 is arranged, and the dielectric multi-layer thin film filter 1 is used as each of the polarizer 6 and the analyzer 8. Therefore, even though the returned laser beam transmitted backward is incident on the polarizer 6 or the analyzer 8, the returned laser beam is reflected on the antireflection film 21 of the polarizer 6 or the analyzer 8. Accordingly, noise occurring in the laser beam radiated from the semiconductor laser 4 due to the returned laser beam can be reduced.

Also, in the first embodiment, each film of the low refractive index type substance is placed between the two films of the high refractive index type substance in the dielectric multi-layer thin film 3 of the dielectric multi-layer thin film filter 1, and the dielectric multi-layer thin film filter 1 is used as each of the polarizer 6 and the analyzer 8. Therefore, because the number of films in the dielectric multi-layer thin film 3 is smaller than that of a short wavelength transmission type filter in which each of films of the high refractive index type substance is placed between the two films of the low refractive index type substance, the thickness of the dielectric multi-layer thin film 3 can be thinned. Accordingly, the wave front aberration of the laser beam can be reduced, and the material cost of the polarizer 6 and the analyzer 8 can be reduced. Also, even though the thermal stress occurs in the polarizer 6 and/or the analyzer 8, the distortion of the dielectric multi-layer thin film 3 can be reduced. Also, the formation time of the dielectric multi-layer thin film 3 can be shortened, and the dielectric multi-layer thin film 3 can be easily formed.

Also, in the first embodiment, the semiconductor laser 4 and the collimator lens 5 are arranged with the optical isolator. Therefore, the laser beam radiated from the semiconductor laser 4 can be efficiently transmitted to the optical fiber 9 through the optical isolator.

Also, in the first embodiment, the optical fiber 9 and the coupling lens 10 are arranged with the optical isolator. Therefore, the laser beam radiated from the semiconductor laser 4 can be efficiently transmitted to the optical fiber 9 through the optical isolator.

Also, in the first embodiment, the laser module comprises the semiconductor laser 4, the optical isolator 12, the coupling lens 10 and the optical fiber 9, and the light amplifier comprises the laser module, the optical signal input terminal 13, the optical signal and excited beam coupler 14 configured to couple the excited laser beam output from the optical module with the optical signal received in the optical signal input terminal 13, and the erbium added optical fiber 15 configured to amplify the optical signal output from the optical signal and excited beam coupler 14 according to the excited laser beam. Therefore, the optical signal can be efficiently amplified in the light amplifier according to the excited laser beam in which noise is reduced.

Also, in the first embodiment, because the optical isolator 16 is arranged on the input side, the output side or both the input and output sides of the erbium added optical fiber 15, the oscillation of the returned laser beam in the light amplifier can be prevented.

Also, in the first embodiment, the light amplifier comprises the semiconductor laser 4, the optical signal input terminal 13, the optical signal and excited beam coupler 14 configured to couple the excited laser beam output from the optical module with the optical signal received in the optical signal input terminal 13, the erbium added optical fiber 15 configured to amplify the optical signal output from the optical signal and excited beam coupler 14 according to the excited laser beam, and the optical isolator 16 is arranged on the input side, the output side or both the input and output sides of the erbium added optical fiber 15. Therefore, the optical signal can be efficiently amplified in the light amplifier using the erbium added optical fiber according to the excited laser beam in which noise is reduced.

Embodiment 2

In a second embodiment, a polarizing filter used for both a polarizer and an analyzer of an optical isolator will be described. When light is incident on the polarizing filter, only one polarization component of the light polarizing in a polarization direction can pass through the polarizing filter.

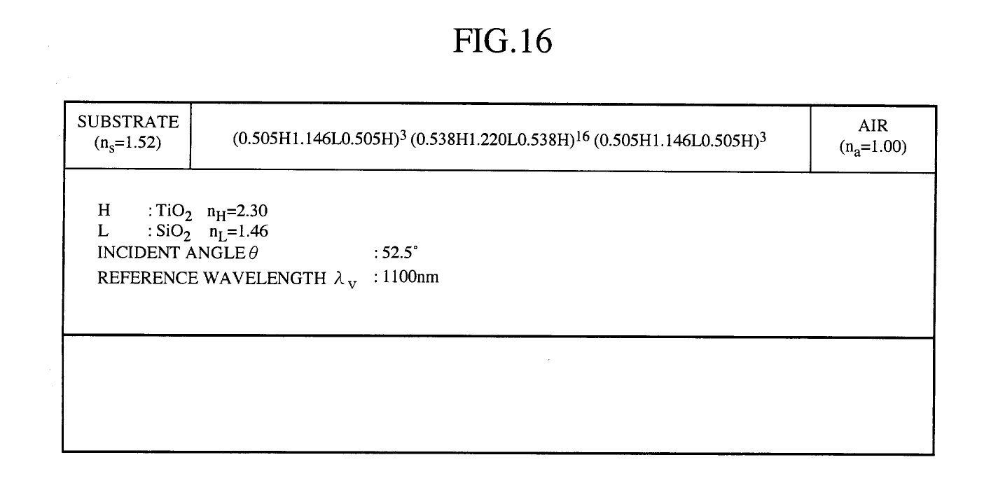

FIG. 16 shows an example of a film structure of a polarizing filter formed of dielectric substances which are used for the dielectric multi-layer thin film 3 shown in FIG. 1.

In FIG. 16, n_{S}, n_{H}, n_{L} and n_{A} denote a refractive index of a substrate, a refractive index of a high refractive index type substance, a refractive index of a low refractive index type substance and a refractive index of air respectively. As dielectric substances composing a dielectric multi-layer thin film, a high refractive index type substance is formed of TiO₂ generally used, and a low refractive index type substance is formed of SiO₂. A refractive index n_{H} of the high refractive index type substance (TiO₂) is equal to 2.30, and a refractive index n_{L} of the low refractive index type substance (SiO₂) is equal to 1.46.

Also, a reference wavelength λv denoting a wavelength of light passing through the vacuum is set to 1100 nm. The reference wavelength λV has reference to a thickness of the high refractive index type substance (or the low refractive index type substance). That is, a length of the high refractive index type substance (or the low refractive index type substance) corresponding to one wavelength is expressed by λV/n_{H} (or λV/n_{L}).

Also, the symbol “H” indicates a value obtained by dividing a quarter (¼×λv) of the reference wavelength by the refractive index n_{H} of the high refractive index type substance, and the symbol “L” indicates a value obtained by dividing a quarter (¼×λv) of the reference wavelength by the refractive index n_{L} of the low refractive index type substance. A thickness of each film of the high refractive index type substance is indicated by 0.505H or 0.538H and is expressed by 0.505×λv/(4×n_{H}) or 0.538×λv/(4×n_{H}), and a thickness of each film of the low refractive index type substance is indicated by 1.146L or 1.220L and is expressed by 1.146×λv/(4×n_{L}) or 1.220×λv/(4×n_{L}). Also, “(0.505H1.146L0.505H)” and “(0.538H1.220L0.538H)” respectively indicate that two films of the high refractive index type substance and a film of the low refractive index type substance are layered so as to place the low refractive index type film between the high refractive index type films.

“(0.505H1.146L0.505H)” indicates that the three films indicated by (0.505H1.146L0.505H) are repeatedly arranged in series three times. “(0.538H1.220L0.538H)¹⁶” indicate that the three films indicated by (0.538H1.220L0.538H) are repeatedly arranged in series sixteen times. Therefore, 66 (=3×3+3×16+3×3) films are layered in the polarizing filter so as to place each film of the low refractive index type substance between the two films of the high refractive index type substance.

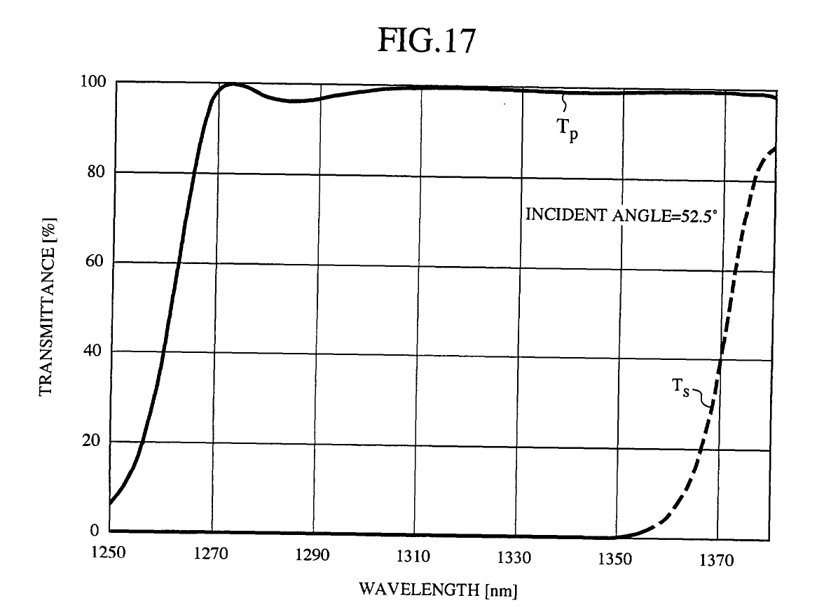

When a polarizing filter is formed of the high refractive index type substance (TiO₂) and the low refractive index type substance (SiO₂) to have a film structure shown in FIG. 16, transmission characteristics of the polarizing filter for both a P-polarized component and an S-polarized component of a laser beam is shown in FIG. 17.

In FIG. 17, an X-axis denotes a wavelength (in nanometer unit) of a laser beam incident on the polarizing film, and a Y-axis denotes a transmittance (%) of a polarized component of the laser beam in the polarizing film. In this case, the laser beam is incident on the polarizing film at an incident angle of θ=52. 5 degrees. A dotted line denotes the transmittance Ts of an S-polarized component of the laser beam in the polarizing film. A solid line denotes the transmittance Tp of a P-polarized component of the laser beam in the polarizing film.

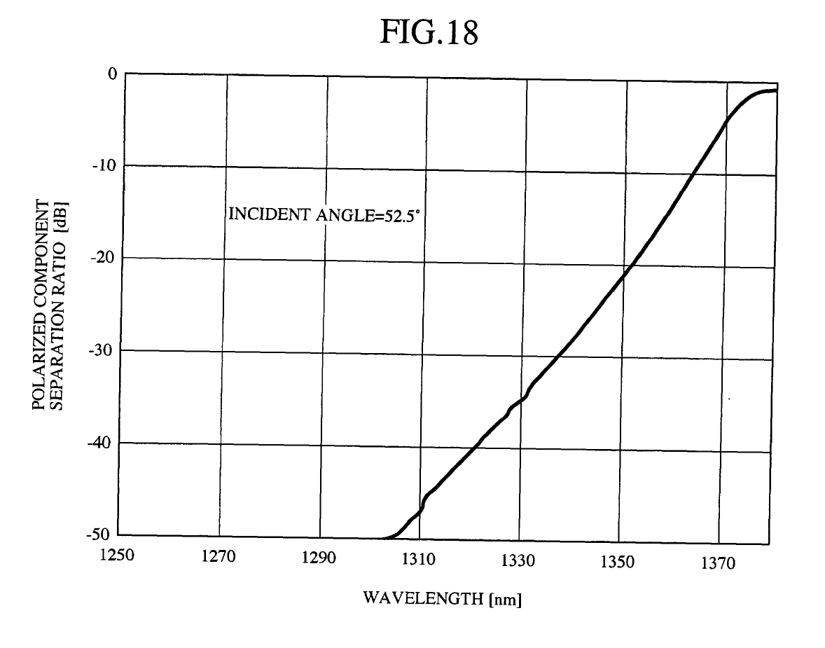

A ratio of the S-polarized component transmittance Ts to the P-polarized component transmittance Tp in the polarizing film is called a polarized component separation ratio, and the polarized component separation ratio obtained from the S-polarized component transmittance Ts and the P-polarized component transmittance Tp shown in FIG. 17 is shown in FIG. 18. In FIG. 18, the polarized component separation ratio is expressed by a unit of dB.

As shown in FIG. 17 and FIG. 18, to separate the P-polarized component and the S-polarized component from each other at a separation ratio higher than a prescribed separation ratio expressed by −30 dB, a wavelength zone allowable for the laser beam ranges from 1250 to 1340 nm. In other words, a width of the wavelength zone is equal to almost 90 nm. Therefore, it is difficult to separate the P-polarized component and the S-polarized component from each other at a high separation ratio in a wide wavelength band equal to or larger than 100 nm.

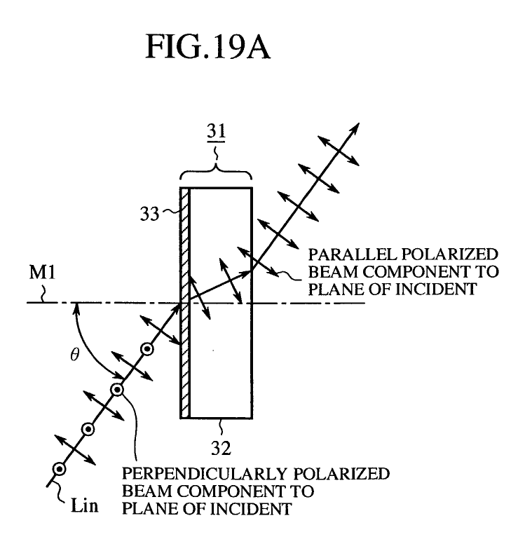

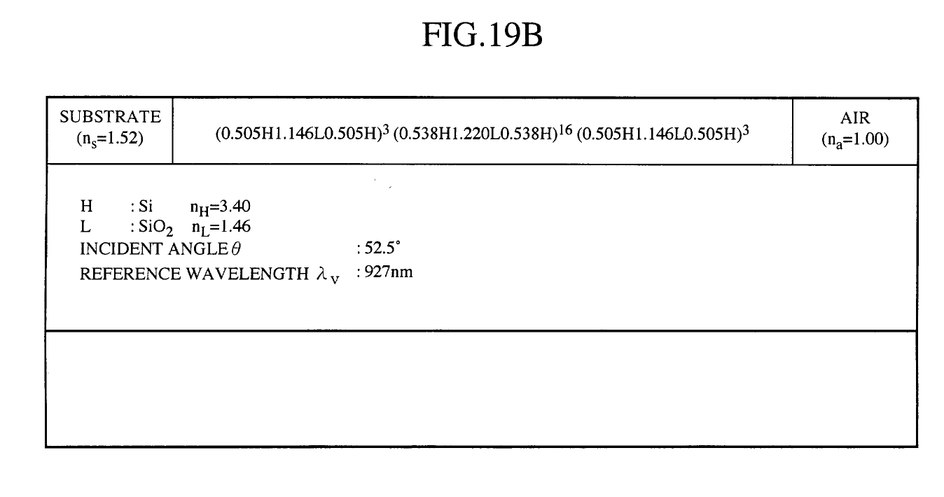

FIG. 19A is a view of the configuration of a polarizing filter according to the second embodiment of the present invention.

In FIG. 19A, 31 indicates a polarizing filter of the second embodiment. 32 indicates a substrate formed of a light transmitting medium such as an optical glass BK7. The substrate 32 is formed in a plane parallel plate shape and functions in the same manner as the light transmitting medium 2 shown in FIG. 1. 33 indicates a dielectric multi-layer thin film arranged on a surface of the substrate 32. A laser beam Lin incident on the dielectric multi-layer thin film 33 passes through the dielectric multi-layer thin film 33 and the substrate 32, and the laser beam Lin goes out into the air.

FIG. 19B shows a film structure of the polarizing filter 31 shown in FIG. 19A.

In FIG. 19B, n_{S}, n_{H}, n_{L} and n_{A}, denote a refractive index of a substrate, a refractive index of a high refractive index type substance, a refractive index of a low refractive index type substance and a refractive index of air respectively. A high refractive index type substance is formed of silicon (Si), and a low refractive index type substance is formed of silicon dioxide (SiO₂). A refractive index n_{H} of the high refractive index type substance (Si) is equal to 3.40 and is higher than that of TiO₂ generally used, and a refractive index n_{L} of the low refractive index type substance (SiO₂) is equal to 1.46.

Also, a reference wavelength denoting a wavelength of light passing through the vacuum is set to λV=927 nm. The reference wavelength λV has reference to a thickness of the high refractive index type substance (or the low refractive index type substance). That is, as is described above with reference to FIG. 16, each film of the high refractive index type substance has an optical thickness of 0.505×λv/(4×n_{H}) or 0.538×λv/(4×n_{H}), and each film of the low refractive index type substance has an optical thickness of 1.146×λv/(4×n_{L}) or 1.220×λv/(4×n_{L}), and 66 (=3×3+3×16+3×3) films are layered as the dielectric multi-layer thin film 33 of the polarizing filter 31 so as to place each film of the low refractive index type substance between the two films of the high refractive index type substance. For example, an optical thickness of each layer of the high refractive index type substance (Si) is equal to about 34.4 nm ((0.505×927)/(4×3.4)) or about 36.7 nm ((0.538×927)/(4×3.4)), and an optical thickness of each layer of the low refractive index type substance (SiO₂) is equal to about 182 nm ((1.146×927)/(4 ×1.46)) or about 194 nm ((1.220×927)/(4×1.46)).

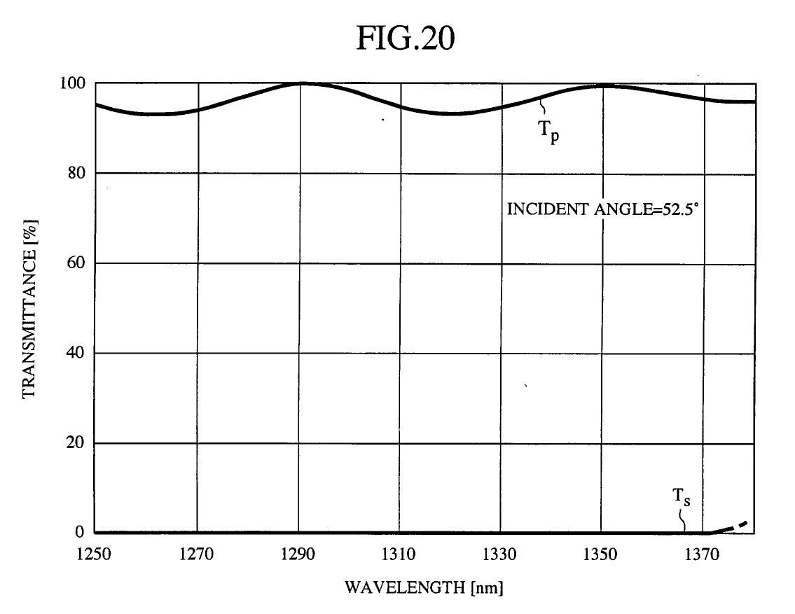

FIG. 20 shows transmission characteristics of the polarizing filter 31 having the film structure shown in FIG. 19B for both a P-polarized component and an S-polarized component of a laser beam.

In FIG. 20, an X-axis denotes a wavelength (in nanometer unit) of a laser beam incident on the polarizing film having the film structure shown in FIG. 19B, and a Y-axis denotes a transmittance (%) of a polarized component of the laser beam in the polarizing film. In this case, the laser beam is incident on the polarizing film at an incident angle of θ=52. 5 degrees. A dotted line denotes the transmittance Ts of an S-polarized component of the laser beam in the polarizing film 31. A solid line denotes the transmittance Tp of a P-polarized component of the laser beam in the polarizing film 31.

As shown in FIG. 20, the transmittance Tp of the P-polarized component is higher than 95% in the wavelength range from 1250 to 1360 nm. In contrast, the transmittance Ts of the S-polarized component is very low.

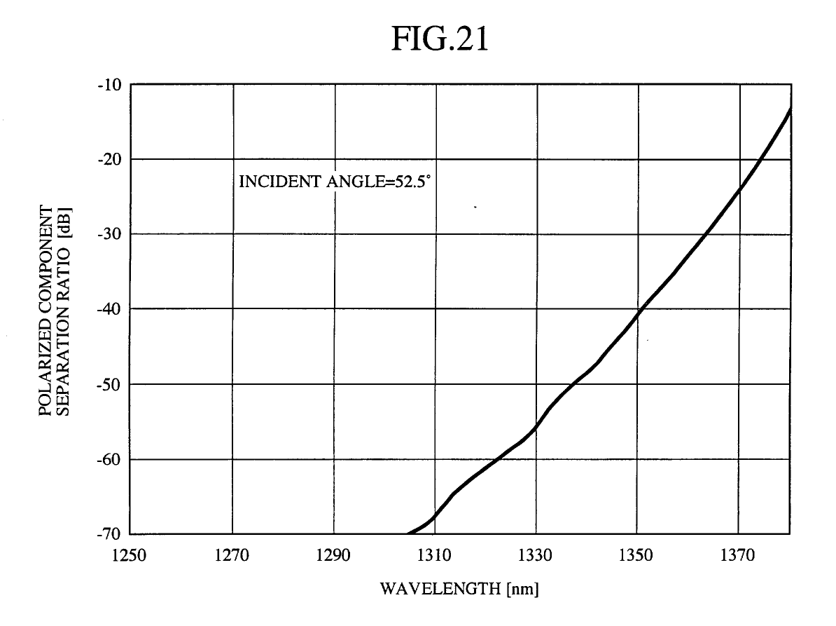

FIG. 21 shows a polarized component separation ratio obtained from an S-polarized component transmittance Ts and a P-polarized component transmittance Tp shown in FIG. 20.

In FIG. 21, a polarized component separation ratio denoting a ratio of the transmittance Ts of S-polarized component to the transmittance Tp of P-polarized component is expressed by a unit of dB. As shown in FIG. 21, the P-polarized component and the S-polarized component are separated from each other in a wavelength band from 1250 nm to 1360 nm at a separation ratio higher than a prescribed separation ratio expressed by −30 dB. In other words, a polarized component separation performance of the polarizing film is very high in the wavelength band having a width larger than 110 nm.

In the polarizing film 31 of the second embodiment, the dielectric substance of SiO₂ is used as the low refractive index type substance. However, even though the dielectric substance of magnesium fluoride (MgF₂) is used as the low refractive index type substance of the polarizing filter 31, the polarizing filter 31 has almost the same polarized component separation performance as that in the dielectric substance of SiO₂. Therefore, it is applicable that the dielectric substance of MgF₂ be used in place of the dielectric substance of Si.

Also, when a dielectric substance multi-layer of the high refractive index type substance and the low refractive index type substance is deposited on the substrate 32, it is preferred that a temperature of the substrate 32 be lowered so as to lower a deposition filling density (or a deposition filling rate) of the low refractive index type substance in the deposition operation. In this case, because an effective refractive index n_{L} of the low refractive index type substance can be lowered, a difference between the refractive index n_{H} of the high refractive index type substance and the refractive index n_{L} of the low refractive index type substance can be enlarged. Therefore, the polarizing film having a high polarized component separation performance in a further wide wavelength band can be obtained. Here, because the deposition filling density of the dielectric substance in the deposition operation is normally set to a value higher than 80% to forma thin film, the lowering of the deposition filling density denotes that the deposition filling density of the dielectric substance in the deposition operation is set to a value lower than 80%.

Accordingly, because the high refractive index type substance (Si) having a refractive index higher than that generally used and the low refractive index type substance (SiO₂ or MgF₂) having a refractive index lower than that generally used are combined with each other, the polarizing filter 31 has a high polarized component separation performance in a wide wavelength band as compared with that of the prior art.

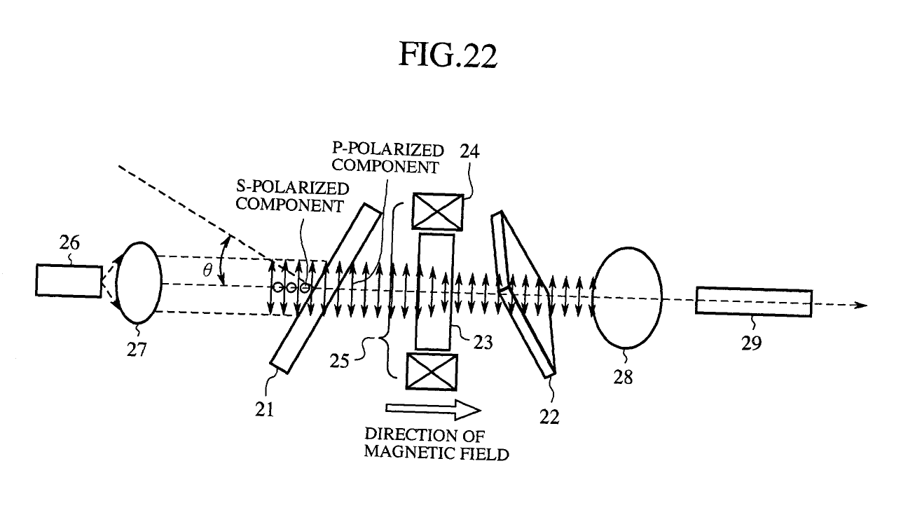

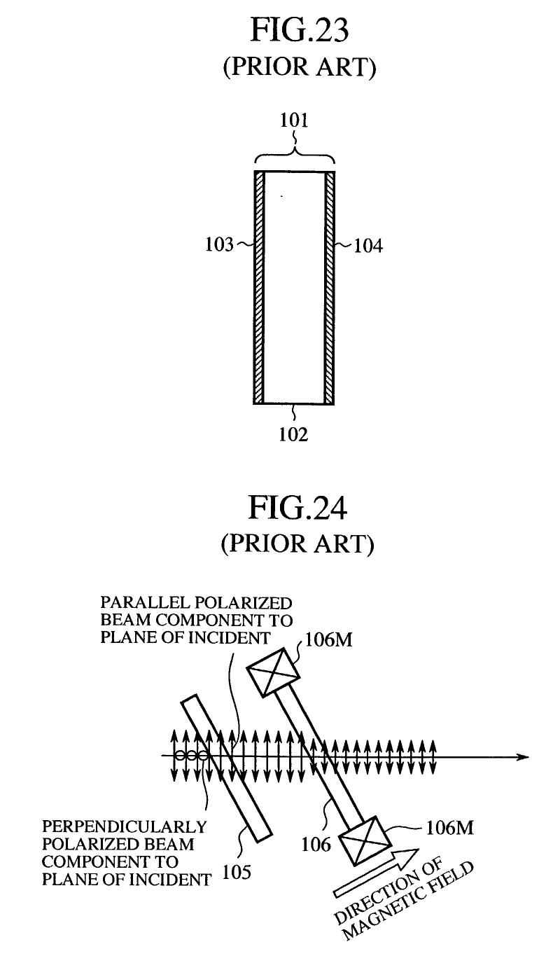

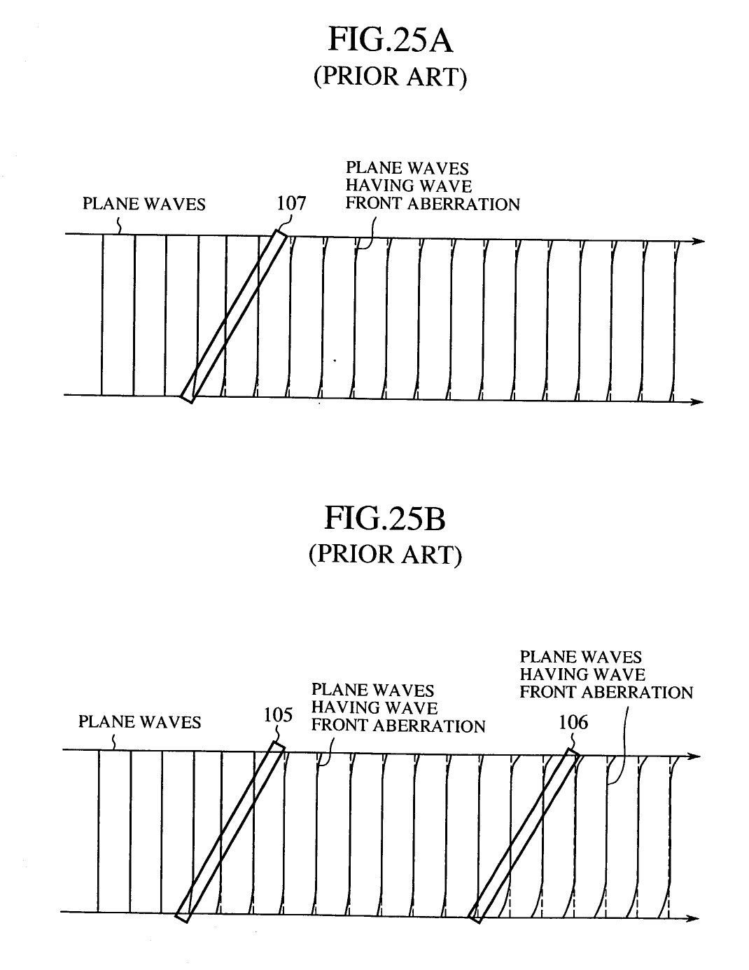

FIG. 22 is a view showing the configuration of a semiconductor laser module having both a semiconductor laser and an optical isolator in which the polarizing filter 31 having the film structure shown in FIG. 19B is used as a polarizer and an analyzer.

In FIG. 22, 21 indicates a polarizer (or a parallel-plate polarizer). The polarizing filter 31 having the film structure shown in FIG. 19B is used as the polarizer 21. 22 indicates an analyzer (or a parallel-plate analyzer). The polarizing filter 31 having the film structure shown in FIG. 19B is used as the analyzer 22. 25 indicates a Faraday rotator (or a rotator). The Faraday rotator 25 has a Faraday effect element 23 and a magnet 24 arranged on the Faraday effect element 25. The Faraday rotator 25 functions in the same manner as the Faraday rotator 7 shown in FIG. 4. The arrangement of the polarizer 21, the analyzer 22 and the Faraday rotator 23 is the same as that of the polarizer 6, the analyzer 8 and the Faraday rotator 7 shown in FIG. 4.

26 indicates a semiconductor laser. 27 indicates a collimator lens (or a beam collimator) configured to collimate the laser beam radiated from the semiconductor laser 26. 29 indicates an optical fiber (or a beam transmitting unit) through which the laser beam transmitted through the polarizer 21, the Faraday rotator 25 and the analyzer 22 in that order is transmitted. 28 indicates a coupling lens (or an optical coupling unit) configured to couple the laser beam output from the analyzer 22 to the optical fiber 29.

Therefore, because the polarizing filter 31 having the film structure shown in FIG. 19B is used as the polarizer 21 and the analyzer 22 in the optical isolator, the P-polarized component and the S-polarized component of a laser beam radiated from the semiconductor laser 26 can be separated from each other in the optical isolator shown in FIG. 22 at an optical isolation performance higher than that of the optical isolator shown in FIG. 4.

Also, when the laser beam radiated from the semiconductor laser 26 is coupled to the optical isolator, a laser beam returned to the semiconductor laser 26 can be reduced. Therefore, noise included in the laser beam due to the returned laser beam to the semiconductor laser 26 can be reduced.

As is described above, in the second embodiment, because the high refractive index type substance (Si) having a refractive index higher than that generally used and the low refractive index type substance (SiO₂ or MgF₂) having a refractive index lower than that generally used are combined with each other to form the polarizing filter 31 having the dielectric multi-layer thin film 33, the optical isolator can have a high polarized component separation performance in a wide wavelength band as compared with that of the prior art.

Also, in the second embodiment, because the low refractive index type substance is disposed on a film-forming surface of the substrate 32 at a deposition filling density lower than 80%, the polarizing film having a high polarized component separation performance in a further wide wavelength band can be obtained.

Also, in the second embodiment, the dielectric substance of Si is used as the high refractive index type substance, and the dielectric substance of SiO₂ or MgF₂ is used as the low refractive index type substance. Therefore, the polarizing film having a high polarized component separation performance in a further wide wavelength band can be obtained.

What is claimed is:

1. An optical isolator, comprising:
a rotator having an optical axis;
a parallel-plate polarizer disposed on the optical axis of the rotator so as to be inclined with respect to the optical axis of the rotator; and
a parallel-plate analyzer disposed on the optical axis of the rotator and opposite to the polarizer through the rotator, and configured to reduce a wave front aberration generated by the polarizer.

2. An optical isolator, comprising:
a rotator having an optical axis, and configured to rotate a polarization of a laser beam by a prescribed rotation angle on the optical axis of the rotator;
a parallel-plate polarizer disposed on the optical axis of the rotator and inclined by a first angle in an inclined direction with respect to the optical axis of the rotator; and
a parallel-plate analyzer disposed on the optical axis of the rotator and opposite to the polarizer through the rotator, and inclined by a second angle in an inclined direction opposite to that of the polarizer with respect to the optical axis of the rotator.

3. An optical isolator, comprising:
a rotator having an optical axis;
a parallel-plate polarizer crossing the optical axis and disposed on one side of the rotator; and
a parallel-plate analyzer crossing the optical axis and disposed on the other side of the rotator,
wherein, as a result, the polarizer, the analyzer and the rotator have substantially the same arrangement as that of an imaginary polarizer, an imaginary analyzer, and an imaginary rotator arranged on condition that
the imaginary analyzer is placed in a perpendicular relationship to an optical axis of the imaginary rotator, and the imaginary polarizer is placed so as to make a first polarization plane of a polarized laser beam allowed to be transmitted through the imaginary polarizer be parallel with a second polarization plane of a polarized laser beam allowed to be transmitted through the imaginary analyzer,
and then the imaginary polarizer and the imaginary analyzer are tilted to each other with respect to the optical axis of the imaginary rotator so as to make a first intersection line of the imaginary polarizer and the first polarization plane face a second intersection line of the imaginary analyzer and the second polarization plane in an almost V shape,
and then the imaginary analyzer is rotated on the optical axis of the imaginary rotator so as to make the first polarization plane incline at an angle of about 45 degrees with respect to the second polarization plane,
and then a rotation angle of the imaginary rotator is set at about 45 degrees by which a polarization plane of a polarized laser beam rotates on the optical axis.

4. An optical isolator according to claim 1, wherein an absolute value of an inclined placement angle of the analyzer from a normal line of a beam entrance plane of the analyzer to an electric field vector of a laser beam is equal to an absolute value of an inclined placement angle of the polarizer from a normal line of a beam entrance plane of the polarizer to the electric field vector of the laser beam, and a sign of the inclined placement angle of the analyzer is in inverse relation to a sign of the inclined placement angle of the polarizer.

5. An optical isolator according to claim 1, wherein an absolute value of an inclined placement angle of the analyzer from the optical axis of the rotator to a normal line of a beam outgoing plane of the analyzer is equal to that of an inclined placement angle of the polarizer from the optical axis of the rotator to a normal line of a beam entrance plane of the polarizer, and a sign of the inclined placement angle of the analyzer is in inverse relation to a sign of the inclined placement angle of the polarizer.

6. An optical isolator according to claim 2, wherein the polarizer or the analyzer is inclined and placed so as to set an inclined placement angle between the optical axis of the rotator and a normal line of a beam entrance plane of the polarizer or the analyzer to a Brewster angle.

7. An optical isolator according to claim 1, wherein the polarizer or the analyzer is inclined and placed so as to set an absolute value of an inclined placement angle between the optical axis of the rotator and a normal line of a beam entrance plane of the polarizer or the analyzer to an angle ranging from 50 to 60 degrees.

8. An optical isolator according to claim 2, wherein the polarization of the laser beam is rotated by the rotator on the optical axis of the rotator by the prescribed rotation angle of 45 degrees, and the second polarization direction of the polarized beam transmission characteristic of the analyzer is equal to a direction which is obtained by rotating the first polarization direction of the polarized beam transmission characteristic of the polarizer by 45 degrees.

9. An optical isolator according to claim 2, wherein the polarizer or the analyzer is formed of a parallel-plate shaped laser beam transmitting medium having a first plane and a second plane parallel to the first plane, a multi-layer film is formed on the first plane, and a thickness of the polarizer or the analyzer from the first plane to the second plane is a maximum of 0.5 mm.

10. An optical isolator according to claim 9, wherein the polarizer or the analyzer is formed of the parallel-plate shaped laser beam transmitting medium having the first plane on which the multi-layer film is formed through no binding layer.

11. An optical isolator according to claim 9, wherein the polarizer or the analyzer is formed of the parallel-plate shaped laser beam transmitting medium having the first plane on which the multi-layer thin film is formed by an oxygen ion assisted electron beam deposit or an oxygen plasma assisted electron beam deposit.

12. An optical isolator according to claim 9, wherein the polarizer or the analyzer is formed of the parallel-plate shaped laser beam transmitting medium having the second plane on which an antireflection film is formed.

13. An optical isolator according to claim 9, wherein the polarizer or the analyzer has a long wavelength transmission type filter formed of the multi-layer film in which a film or a plurality of films of a low refractive index type substance having a changeable film thickness and a plurality of films of a high refractive index type substance having a changeable film thickness are layered so as to place each film of the low refractive index type substance between the two films of the high refractive index type substance.

14. An optical isolator according to claim 1, wherein the polarizer or the analyzer is formed of a polarizing filter having a parallel-plate shaped dielectric multi-layer film, the parallel-plate shaped dielectric multi-layer film is formed by combining a plurality of high refractive index type dielectric thin films and a plurality of low refractive index type dielectric thin films, and a deposition filling rate of a substance of the low refractive index type dielectric thin films deposited on a film-forming surface is set to a value lower than 80%.

15. An optical isolator according to claim 14, wherein each high refractive index type dielectric thin film is formed of silicon, and each low refractive index type dielectric thin film is formed of silicon dioxide or magnesium fluoride.

16. A laser module, comprising:
an optical isolator;
a laser beam source configured to radiate a laser beam; and
a beam collimator configured to collimate the laser beam radiated from the laser beam source and sending the laser beam to the optical isolator,
wherein the optical signal comprises
a rotator having an optical axis;
a parallel-plate polarizer placed so as to be inclined with respect to the optical axis of the rotator, and having a polarized beam transmission characteristic of a first polarization direction; and
a parallel-plate analyzer placed across the rotator from the polarizer, and configured to reduce a wave front aberration generated by the polarizer, the analyzer having a polarized beam transmission characteristic of a second polarization direction.

17. A laser module according to claim 16, further comprising:
a beam transmitting unit configured to transmit the laser beam; and
an optical coupling unit configured to couple the laser beam output from the optical isolator with the beam transmitting unit.

18. A light amplifier, comprising:
a laser module;
an optical signal receiving unit configured to receive an optical signal;
an optical signal and excited beam coupling unit configured to couple the optical signal received by the optical signal receiving unit with a laser beam which is output from the laser module and functions as an excited laser beam; and
an optical signal amplifying path configured to receive the optical signal and the excited laser beam from the optical signal and excited beam coupling unit, amplifying the optical signal according to the excited laser beam and outputting the optical signal,
wherein the laser module comprises
an optical isolator comprising
a rotator having an optical axis;
a parallel-plate polarizer placed so as to be inclined with respect to the optical axis of the rotator, and having a polarized beam transmission characteristic of a first polarization direction; and
a parallel-plate analyzer placed across the rotator from the polarizer, and configured to reduce a wave front aberration generated by the polarizer, the analyzer having a polarized beam transmission characteristic of a second polarization direction,
a laser beam source configured to radiate a laser beam, and
a beam collimator configured to collimate the laser beam radiated from the laser beam source and sending the laser beam to the optical isolator.

19. A light amplifier according to claim 18, further comprising:
a second optical isolator which is placed on an input side or an output side of the optical signal amplifying path, wherein the second optical isolator comprises
a rotator having an optical axis;
a parallel-plate polarizer placed so as to be inclined with respect to the optical axis of the rotator, and having a polarized beam transmission characteristic of a first polarization direction; and
a parallel-plate analyzer placed across the rotator from the polarizer, and configured to reduce a wave front aberration generated by the polarizer, the analyzer having a polarized beam transmission characteristic of a second polarization direction.

20. A light amplifier, comprising:
an optical isolator;
a laser beam source configured to radiate an excited laser beam;
an optical signal receiving unit configured to receive an optical signal;
an optical signal and excited beam coupling unit configured to couple the optical signal received by the optical signal receiving unit with the excited laser beam radiated from the laser beam source; and
an optical signal amplifying path configured to receive the optical signal and the excited laser beam from the optical signal and excited beam coupling unit, amplifying the optical signal according to the excited laser beam and outputting the optical signal,
wherein the optical isolator is placed on an input side or an output side of the optical signal amplifying path and comprises
a rotator having an optical axis;
a parallel-plate polarizer placed so as to be inclined with respect to the optical axis of the rotator, and having a polarized beam transmission characteristic of a first polarization direction; and
a parallel-plate analyzer placed across the rotator from the polarizer, and configured to reduce a wave front aberration generated by the polarizer, the analyzer having a polarized beam transmission characteristic of a second polarization direction.

21. A light amplifier according to claim 20, wherein the optical signal amplifying path is formed of a rare earth added optical fiber which is obtained by adding a rare earth element to an optical fiber so as to be excited by the excited laser beam to amplify the optical signal.

22. An optical isolator, comprising:
a parallel-plate polarizer having a first polarization direction which is parallel to a first polarization plane of a polarized laser beam allowed to be transmitted through the polarizer;
a parallel-plate analyzer having a second polarization direction which is parallel to a second polarization plane of a polarized laser beam allowed to be transmitted through the analyzer;
a rotator disposed between the polarizer and the analyzer, and having an optical axis crossing the polarizer and the analyzer, the rotator rotating a polarization of a polarized laser beam on the optical axis by a rotation angle of about 45 degrees in a direction of rotation;
wherein, as a result, the polarizer and the analyzer have substantially the same arrangement as that of an imaginary polarizer and an imaginary analyzer arranged on condition that
the imaginary analyzer is placed in a parallel relationship to the imaginary polarizer so as to make the second polarization direction of the analyzer be parallel with the first polarization direction of the polarizer,
and then the imaginary analyzer is rotated on the optical axis of the rotator by a rotation angle of about 225 degrees in the direction of rotation of the rotator.

23. An optical isolator, comprising:
a parallel-plate polarizer having a first polarization direction which is parallel to a first polarization plane of a polarized laser beam allowed to be transmitted through the polarizer;
a parallel-plate analyzer having a second polarization direction which is parallel to a second polarization plane of a polarized laser beam allowed to be transmitted through the analyzer;
a rotator disposed between the polarizer and the analyzer, and having an optical axis crossing the polarizer and the analyzer, the rotator rotating a polarization of a polarized laser beam on the optical axis by a rotation angle of about 45 degrees in a direction of rotation;
wherein, as a result, the polarizer and the analyzer have substantially the same arrangement as that which is made by the following steps of
disposing the analyzer in a parallel relationship to the polarizer so as to make the second polarization direction of the analyzer be parallel with the first polarization direction of the polarizer, and
rotating the analyzer on the optical axis of the rotator by a rotation angle of about 225 degrees in the direction of rotation of the rotator.

24. A polarizing filter, comprising:
a film-forming plane;
a plurality of high refractive index type dielectric thin films formed on the film-forming plane; and
a plurality of low refractive index type dielectric thin films formed on the film-forming plane so as to form a dielectric multi-layer film with the high refractive index type dielectric thin films.

25. A polarizing filter according to claim 24, wherein each low refractive index type dielectric thin film is formed by lowering a deposition filling rate of the low refractive index type dielectric thin film on the film-forming plane to a value lower than 80%.

26. A polarizing filter according to claim 24, wherein each high refractive index type dielectric thin film is formed of silicon, and each low refractive index type dielectric thin film is formed of silicon dioxide or magnesium fluoride.
